(19) United States
(12) Patent Application Publication
(10) Pub. No.: US 2008/0088065 A1
(43) Pub. Date: Apr. 17, 2008

(54) CELLULOSE RESIN FILM, METHOD FOR PRODUCING THE SAME AND FILM PRODUCT THEREOF

(75) Inventor: Tadashi UEDA, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/871,738

(22) Filed: Oct. 12, 2007

(30) Foreign Application Priority Data
Oct. 12, 2006 (JP) 2006-279077

(51) Int. Cl. B29C 35/08; B29C 39/00

(52) U.S. Cl. 264/405; 264/330; 264/334

(57) ABSTRACT

An aspect of the present invention provides a method for producing a cellulose resin film, comprising the step of: casting a cellulose resin sheet obtained by discharging from a molten cellulose resin a die in a form of a sheet onto a drum to produce a film, wherein the cast cellulose resin sheet has a film thickness distribution of 5 μm or less per 10 m in terms of the lengthwise direction of the film, and the maximum value of a scratch depth on at least one surface of the cellulose resin sheet is 1 μm or less. According to the first aspect, a film excellent in surface smoothness can be obtained, and thus the film can be used as a base film in various film products.

### BACKGROUND OF THE INVENTION

1. Field of the Invention

The present invention relates to a cellulose resin film and a method for producing the same, and a film product thereof, in particular, a cellulose resin film such as a cellulose acylate film preferably used in a liquid crystal display device, a method for producing the same and a film product thereof for a liquid crystal display device.

2. Description of the Related Art

A cellulose resin film such as a cellulose acylate film is obtained by melting and extruding a cellulose resin by an extruder into a die and discharging the molten cellulose resin from a discharge opening of the die in a form of a sheet so as to be solidified by cooling (referred to as a melt film formation method). Then, by stretching in at least one direction of a lengthwise direction (longitudinal direction; MD) and a widthwise direction (transverse direction; TD), a film having a desired in-plane retardation (R^{e}) and a desired thickness retardation (Rth) can be obtained. This film is used for an optical compensation film (also referred to as a retardation film) of a liquid crystal display device, and the enlargement of a visual angle has been intended to perform (for example see National Publication of International Patent Application No. 6-501040).

### SUMMARY OF THE INVENTION

In a conventional melt film formation method, however, a molten cellulose resin sheet discharged from a die starts solidification by cooling until the cellulose resin reaches a casting drum. Therefore, there causes a problem such that the resin sheet, which reaches the casting drum, has difficulty in exerting a leveling effect to make the surface thereof smooth. Accordingly, there are problems such that a film thickness distribution is caused on an obtained film, and that scratches (also referred to as die scratches) occurring at the time of discharging the resin from a die remain.

Therefore, objects of the present invention are to control the film thickness distribution in the longitudinal direction of a film within a constant range and to suppress remaining die scratches caused at the time of discharging the molten resin from a die as well.

A first aspect of the present invention is characterized in that, for the purpose of achieving the above-mentioned objects, in a method for producing a cellulose resin film, comprising the step of: casting a cellulose resin sheet obtained by discharging from a molten cellulose resin a die in a form of a sheet onto a drum to produce a film, wherein the cast cellulose resin sheet has a film thickness distribution of 5 μm or less per 10 m in terms of the lengthwise direction of the film, and the maximum value of a scratch depth on at least one surface of the cellulose resin sheet is 1 μm or less. According to the first aspect, a film excellent in surface smoothness can be obtained, and thus the film can be used as a base film in various film products.

A second aspect of the present invention is characterized in that, for the purpose of achieving the above described objects, in a method for producing a cellulose resin film, comprising the step of discharging a molten cellulose resin from a die in a form of a sheet and casting the cellulose resin sheet onto a drum to produce a film, wherein the temperature of the cast cellulose resin sheet at the casting position is kept within a range from 150° C. or higher to 230° C. or lower. According to the second aspect, since the cellulose resin sheet discharged from a die is heated until the resin is cast onto a casting drum, a viscosity of the cellulose resin sheet can be controlled. Therefore, the cellulose resin sheet tends to easily exert smoothing (leveling effect) of the surface thereof due to its surface tension on the casting drum, and thus a cellulose resin film having a small film thickness distribution (thickness unevenness) can be obtained. In a third aspect of the present invention, it is preferable that decrease in the temperature of the cellulose resin sheet discharged from a die until being cast onto the drum is within 20° C. or less.

In a forth aspect of the present invention, it is preferable that the cellulose resin sheet is heated to have a temperature within a range from (solid-solid phase transition temperature+50)° C. or higher to (solid-solid phase transition temperature+250° C. or lower.

In a fifth aspect of the present invention, it is preferable that the solid-solid phase transition temperature is a glass transition temperature Tg (° C.) of the cellulose resin.

In a sixth aspect of the present invention, it is preferable that the cellulose resin sheet is heated with a heater.

In a seventh aspect of the present invention, it is preferable that the distance L1 (mm) between at least one surface of the cellulose resin sheet and a surface of the first heater disposed on the one surface side is 10 mm or more and 150 mm or less.

In an eighth aspect of the present invention, it is preferable that the length H1 (mm) for which the cellulose resin sheet is heated with the first heater in a casting direction is 5 mm or more and 300 mm or less.

In a ninth aspect of the present invention, it is preferable that a second heater is further disposed on a surface opposite to the one surface of the cellulose resin sheet.

In a tenth aspect of the present invention, it is preferable that the distance L2 (mm) between the opposite surface of the cellulose resin sheet and the surface of the second heater is 10 mm or more and 150 mm or less.

In an eleventh aspect of the present invention, it is preferable that the length H2 (mm) for which the cellulose resin sheet is heated with the second heater in the casting direction is 5 mm or more and 300 mm or less.

In a twelfth aspect of the present invention, it is preferable that the heaters emit electromagnetic waves of 0.7 μm or more and 1000 μm or less so as to heat the cellulose resin sheet. According to the twelfth aspect, since heating of the cellulose resin sheet is carried out with a heater, preferably, an electromagnetic wave emitting heater, fluctuation in thickness such as unevenness caused on the surface of the cellulose resin sheet can be suppressed. Furthermore, since the wavelength of the electromagnetic wave emitted from the electromagnetic wave emitting heater is 0.7 μm or more and 1000 μm or less, there is no adverse effect such as decomposition of a cellulose compound constituting a cellulose resin.

In a thirteenth aspect of the present invention, it is preferable that the cellulose resin sheet is subjected to leveling on the surface of the drum at the time of casting the cellulose resin sheet onto the drum.

In a fourteenth aspect of the present invention, it is preferable to use a drum having an arithmetic average roughness (R^{a}) of the drum surface of 0.3 μm or less. According to the fourteenth aspect, using a casting drum (roller) having an arithmetic average roughness (Ra) of the casting drum surface of 0.3 μm or less enables the obtained cellulose resin film to have a small film thickness distribution (thickness unevenness) of a surface in contact with a roller.

In a fifteenth aspect of the present invention, it is preferable that, in a method in which the cellulose resin sheet is cast between two drums, a reaching point of the cellulose resin sheet to the other drum is set at an approximately constant position by setting a position of one of the drums.

In a sixteenth aspect of the present invention, it is preferable that the cellulose resin sheet has a viscosity of 100 Pa·s or more and 2000 Pa·s or less when the viscosity is measured under the conditions at 25° C. and 60% RH by a capillary rheometer method. According to the sixteenth aspect, the viscosity of the cellulose resin sheet is set within the above range, and hence the leveling effect after casting tends to be easily exhibited.

A seventeenth aspect of the present invention is a cellulose resin film characterized by being produced by the method for producing a cellulose resin film according to any one of the first to sixteenth aspects. Eighteenth to twentieth aspects of the present invention are a polarizing plate, an optical compensation film, and an antireflection film characterized by being constituted by using the cellulose resin film according to the seventeenth aspect.

According to the present invention, a film thickness distribution in a lengthwise direction of a film can be controlled in a constant range, and at the same time, remaining die scratches produced at the time of discharging a molten resin from a die can be decreased.

### BRIEF DESCRIPTION OF THE DRAWINGS

FIG. 1 is a schematic view illustrating a production line for producing the cellulose resin film of the present invention; and

FIG. 2 is an enlarged view showing the main part of the production line illustrated in FIG. 1.

### DETAILED DESCRIPTION OF THE PREFERRED EMBODIMENTS

Hereinafter, preferred embodiments of the method for producing a cellulose resin film according to the present invention will be described. Although an example of the production of a cellulose acylate film is described in the present embodiments, the present invention is not limited to the present embodiments, but can be applied to the production of a film made of a cellulose resin as a raw material other than cellulose acylate.

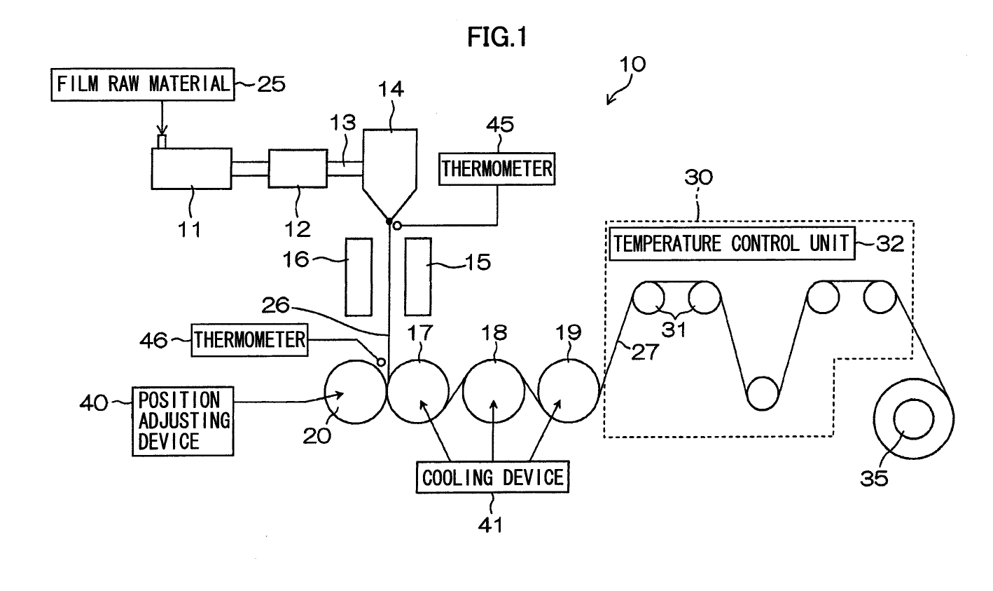

FIG. 1 shows an example of a schematic configuration illustrating a production line 10 of a cellulose acylate film. The production line 10 is constituted with an extruder 11, a gear pump 12, a piping 13, a die 14, heaters 15 and 16, drums 17, 18 and 19, a position adjusting drum 20, a roller 31, a winding-up device 35 and the like.

It is preferable to use the gear pump 12 as an apparatus (pump) for feeding a film raw material 25 made of cellulose acylate as the main component to the production line. Even though the gear pump 12 has a large extrusion pressure, a specific extrusion rate does not vary. Therefore, the gear pump 12 has an advantage such that a temperature increase of an extruded polymer due to shear heat generation is small. Further, even though a gear rotational speed becomes large, the shear heat generation is small to result in, accompanying with the small shear heat generation, suppressing increase in extrusion temperature. Therefore, the specific extrusion rate does not vary, which makes it possible to stably feed the film raw material 25 to the production line 10. As described above, it is possible to suppress degradation caused by thermal decomposition of cellulose acylate that is weak against heat (for example, cellulose acylate propionate (CAP), a representative example of cellulose acylate, has a thermal decomposition temperature of about 250° C.).

The film raw material 25 is fed from a hopper (not shown) to the extruder 11, and is molten in the extruder 11 to be a fluid (hereinafter referred to as molten cellulose acylate). An extrusion temperature from the extruder 11 is preferably 190° C. or higher and 240° C. or lower, more preferably 195° C. or higher and 235° C. or lower, and particularly preferably 200° C. or higher and 230° C. or lower. When the extrusion temperature is lower than 190° C., insufficient melting of a cellulose acylate crystal may be caused. Thus, fine crystals tend to remain in the obtained cellulose acylate film. Even when stretching the cellulose acylate film is stretched, stretchability is inhibited, and orientation of a cellulose acylate molecule cannot be controlled sufficiently, and thus desired retardation ratios (Re and Rth) may not be obtained. In some cases, a problem such as film breakage is also caused. On the other hand, when the extrusion temperature exceeds 240° C., degradation such as thermal decomposition in cellulose acylate may occur. A film obtained from degraded cellulose acylate tends to aggravate yellowing (YI value).

The molten cellulose acylate is transferred by the gear pump 12 passing through in the piping 13, and thereafter, sent to the die 14. In addition, it is preferable to place a temperature control unit (not shown) in the piping 13 so as to maintain a specified predetermined temperature. The molten cellulose acylate is discharged from the die 14 in a form of a sheet (hereinafter referred to as cellulose acylate sheet 26) to cast onto a drum 17 (hereinafter referred to as a casting drum). The position adjusting drum 20 may be disposed facing the casting drum 17 shown in FIG. 1 to perform a touch roll method in which the cellulose acylate sheet 26 is cast between these drums 17 and 20 in the present invention. In addition, a position adjusting device 40 is placed in the position adjusting drum 20. Drums for cooling 18 and 19 (hereinafter referred to as cooling drums) are provided in the downstream of the side of the casting drum 17.

FIG. 1 illustrates an example of disposing two cooling drums 18 and 19, however, the number of cooling drums disposed are not limited to two in the present invention. Further, it is preferable that each of the drums 17 to 19 is connected to the cooling device 41 so as to independently perform temperature control in each of the drums 17 to 19. Although the temperature of each of the drums 17 to 19 is not particularly limited, the temperature of the casting drum 17 is preferably 45° C. or higher and 160° C. or lower, and the temperature of the cooling drums 18 and 19 is preferably 60° C. or higher and 150° C. or lower. The cellulose acylate sheet 26 is cooled on the surface of each of the drums 17 to 19. Hereinafter, the cooled cellulose acylate sheet 26 is referred to as the cellulose acylate film 27.

Then, the cellulose acylate film 27 is sent to the cooling zone 30 and transferred while being wound around to the roller 31 so as to be further cooled. It is preferable to provide the temperature control unit 32 in the cooling zone 30, and the temperature in the cooling zone 30 is preferably 20° C. or higher and 70° C. or lower. Further, the cooling zone 30 may be divided into several sections to perform temperature control in each of the sections.

The cellulose acylate film 27 adjusted to a desired temperature (for example, 25° C. or higher and 40° C. or lower) in the cooling zone 30 is wound up in a form of a roll by the winding-up device 35. The film formation speed of the cellulose acylate film 27 is not particularly limited in the present invention, but the film formation speed is preferably 3 m/min or more and 200 m/min or less, more preferably 10 m/min or more and 150 m/min or less, most preferably 20 nm/min or more and 100 m/min or less. In addition, the process for producing a cellulose resin film according to the present invention is preferably applied to a film having an average film thickness of 60 μm or more and 120 μm or less, more preferably applied to a film having an average film thickness of 70 μm or more and 110 μm or less, and most preferably applied to a film having an average film thickness of 80 μm or more and 100 μm or less.

The temperature of the cellulose acylate sheet 26 is kept in a constant range in the present invention, which makes it possible to keep a viscosity of the cellulose acylate sheet 26 in a constant range. Accordingly, the leveling effect is exerted in the cellulose acylate sheet 26 on the casting drum 17 and the cooling drums 18 and 19. Due to the leveling effect, a film thickness distribution of the obtained cellulose acylate film 27 is within 5 μm or less per 10 m in the lengthwise direction (film formation direction), with more selective conditions, it is within 3 μm or less, and with the most selective conditions, it is within 1 μm or less. In addition, the depth of scratches (also referred to as die scratches) produced at the time of discharging the molten cellulose acylate from the die 14 decreases when cellulose acylate sheet 26 has low viscosity since the leveling effect is easily exerted. According to the conditions of the present invention, the maximum depth of a scratch is 1 μm or less, with more selective conditions, it is 0.5 μm or less, and with the most selective conditions, it is 0.3 μm or less.

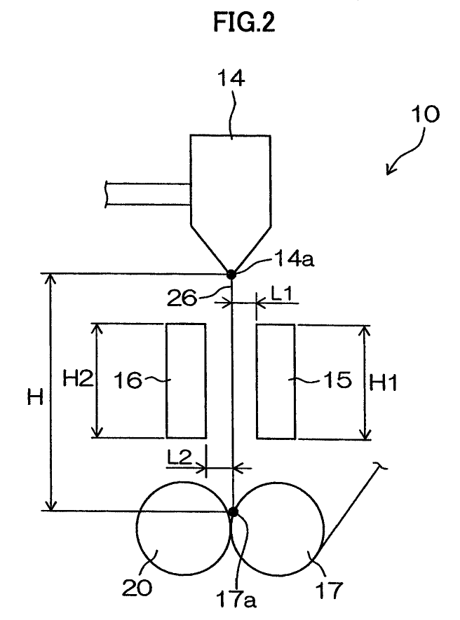

FIG. 2 shows an enlarged view illustrating the main part of the production line 10. The position adjusting drum 20 can be omitted also in FIG. 2. In the present invention, it is important that the temperature T1 (° C.; initial temperature) of the cellulose acylate sheet 26 at the die discharge opening 14a and the temperature T2 (° C.; terminal temperature) of the cellulose acylate sheet 26 at the position 17a where the cellulose acylate sheet 26 is cast onto the casting drum 17 fall within the desired temperature ranges. Namely, it is preferable that the initial temperature T1 falls within a range from 150° C. or higher to 250° C. or lower, more preferable from 170° C. or larger to 240° C. or lower, and most preferably from 190° C. or larger to 230° C. or lower. On the other hand, it is preferable that the terminal temperature T2 falls within a range from 130° C. or higher to 240° C. or lower, more preferable from 150° C. or higher to 230° C. or lower, and most preferably from 170° C. or higher to 220° C. or lower. Keeping the temperature of the cellulose acylate sheet 26 within the above-described range makes it possible to suppress the die scratches produced in the molten cellulose acylate at the die discharge opening 14a, and at the same time, the leveling effect on the casting drum 17 tends to be easily exhibited. More desirably, decrease in a temperature ΔT (° C.; initial temperature T1 -terminal temperature T2) is preferably within 20° C. or less, more preferably within 10° C. or less, and most preferably 5° C. or less.

Alternatively, the temperatures of the cellulose acylate sheet 26 (initial temperature T1 and terminal temperature T2) can be based on the solid-solid phase transition temperature of the cellulose acylate. For example, the temperature of the cellulose acylate sheet 26 preferably falls within a range from (solid-solid phase transition temperature+50)° C. or higher to (solid-solid phase transition temperature+250)° C. or lower, more preferably from (solid-solid phase transition temperature+70)° C. or higher to (solid-solid phase transition temperature+230)° C. or lower, and most preferably from (solid-solid phase transition temperature+90)° C. or higher to (solid-solid phase transition temperature+220)° C. or lower. In addition, an example of the solid-solid phase transition temperature is a glass transition temperature.

In the present invention, measurement of the initial temperature T1 and the terminal temperature T2 is carried out with noncontact thermometers 45 and 46 provided respectively near the die discharge opening 14a and the casting position 17a. The noncontact thermometers 45 and 46 are not particularly limited; however, it is preferable to use a thermo vision and the like.

Means for keeping the initial temperature T1 and the terminal temperature T2 of the cellulose acylate sheet 26 within the above described range is not particularly limited; however, it is preferable to use heaters 15 and 16, and more preferable to use an infrared ray heater. In order not to give an effect on cellulose acylate molecules by electromagnetic waves emitted from the infrared ray heater, the infrared ray heater preferably emits electromagnetic wave of 0.7 μm or more and 1000 μm or less, and more preferably 4 μm or more and 1000 μm or less.

The heaters may be disposed on one side or both sides of the heater 15 on a surface of the cellulose acylate sheet in contact with the casting drum (hereinafter referred to as a contact surface) and the heater 16 on a surface of the cellulose acylate sheet not in contact with the casting drum (hereinafter referred to as a noncontact surface). A distance L1 (mm) between the contact surface of the cellulose acylate sheet 26 and a surface of the heater 15 in the side of the contact surface is preferably 3 mm or more and 300 mm or less, more preferably 5 mm or more and 200 mm or less, and most preferably 10 mm or more and 150 mm or less.

On the other hand, a distance L2 (mm) between the noncontact surface of the cellulose acylate sheet 26 and a surface of the heater 16 in the side of the noncontact surface is preferably 3 mm or more and 300 mm or less, more preferably 5 mm or more and 200 mm or less, and most preferably 10 mm or more and 150 mm or less.

Further, a length H1 (mm) for heating the cellulose acylate sheet 26 with the contact side heater 15, and a length H2 (mm) for heating the cellulose acylate sheet 26 with the noncontact side heater 16 are both preferably 1 mm or more and 500 mm or less, more preferably 3 mm or more and 400 mm or less, and most preferably 5 mm or more and 300 mm or less.

The cellulose acylate sheet 26 cast onto the casting roller 17 exerts the leveling effect to make its surface smooth due to the surface tension thereof. In order to favorably exhibit the leveling effect, the viscosity of the cellulose acylate sheet 26 preferably falls within the range from 100 Pa·s or more to 2000 Pa·s or less, more preferably from 300 Pa·s or more to 1500 Pa·s or less, most preferably from 500 Pa·s or more to 1000 Pa·s or less. It is important in the present invention that the cellulose acylate sheet 26 is heated by the heaters 15 and 16 so as to set the viscosity thereof within the above described range. It is to be noted that the viscosity of the cellulose acylate sheet 26 to be used in the present invention is a value measured under the conditions at 25° C. and 60% RH in a capillary rheometer method.

An arithmetic average roughness (Ra) of the surface of the casting drum 17 is preferably 0.3 μm or less, more preferably 0.1 μm or less, most preferably 0.05 μm or less. In addition, a lower limit of the arithmetic average roughness (Ra) is not particularly limited, but production of a drum having a too small roughness costs a lot. Therefore, when the arithmetic average roughness is 0.05 μm or more, no particular problems occur, such as an adverse effect on exhibition of the leveling effect in the present invention.

In the present invention, it is preferable that the casting position 17a of the cellulose acylate sheet 26 is approximately constant. Accordingly, it is preferable to dispose a device for setting the casting position to be constant. FIGS. 1 and 2 illustrate configurations where the position adjusting drum 20 is disposed at a position facing the casting drum 17 (touch roll method). A position adjusting device 40 is installed in the position adjusting drum 20. By a casting position detector that is not shown, when the casting position 17a of the cellulose acylate sheet 26 is found to change, the position adjusting device 40 starts up and moves the position adjusting drum 20 to a desired position so as to perform adjustment of the casting position 17a to an approximately constant position.

The wound up cellulose acylate film can be subjected to stretching described later. The stretching of the cellulose acylate film is carried out for the purpose of developing the in-plane retardation (R^{e}) and the thicknesswise retardation (Rth) by orienting the molecules in the cellulose acylate film. Here, the retardations Re and Rth are derived from the following formulas:
Re (nm)=|n(MD)−n(TD)|×T(nm)
Rth(nm)=|{(n(MD)+n(TD))/2}−n(TH)|×T(mm)
wherein n(MD), n(TD) and n(TH) represent the refractive indexes along the lengthwise, widthwise and thicknesswise directions, respectively, and T represents the film thickness given in nm units.

The cellulose acylate film is first longitudinally stretched along the lengthwise direction in the longitudinal stretching section. In the longitudinal stretching section, the cellulose acylate film is preheated, and then wound around two niprolls under the condition that the cellulose acylate film is being heated. The niproll on the exit side conveys the cellulose acylate film at a convey speed faster than the convey speed of the niproll on the entry side, and thus the cellulose acylate film is stretched along the longitudinal direction.

The longitudinally stretched cellulose acylate film is transferred to the transverse stretching section to be transversely stretched along the widthwise direction. In the transverse stretching section, for example, a tenter can be preferably used. With this tenter, both widthwise edges of the cellulose acylate film are gripped with clips to be stretched along the transverse direction (widthwise direction). This transverse stretching can further increase the retardation Rth.

By carrying out the above described longitudinal and transverse stretching treatments, a stretched cellulose acylate film developing retardations Re and Rth can be obtained. Re of the stretched cellulose acylate film is 0 nm or more and 500 nm or less, preferably 10 nm or more and 400 mm or less, more preferably 15 nm or more and 300 nm or less, and Rth is 30 nm or more and 500 nm or less, preferably 50 nm or more and 400 nm or less, more preferably 70 nm or more and 350 nm or less. Among the stretched films satisfying the above described conditions, more preferable are the stretched films satisfying the relation Re≦Rth, and furthermore preferable are the stretched films satisfying the relation Re×2≦Rth. For the purpose of realizing such a high Rth and such a low Re, it is preferable to stretch the longitudinally stretched film along the transverse (widthwise) direction, as described above. In other words, the orientation difference between the longitudinal direction and the transverse direction makes the difference of the in-plane retardation (Re), and accordingly, the in-plane orientation (Re) can be made small by reducing the difference between the longitudinal and transverse orientations through the transverse stretching, namely, the stretching along the direction perpendicular to the longitudinal direction, in addition to the longitudinal stretching. In other words, this is because the transverse stretching in addition to the longitudinal stretching increases the area magnification, thus the thickness is decreased and the thicknesswise-direction orientation is increased, and Rth can thereby be increased.

Further, the widthwise and lengthwise fluctuations of Re and Rth each as a function of the position are all made to be preferably 5% or less, more preferably 4% or less and furthermore preferably 3% or less. Further, the orientation angle is preferably set at 90°±5° or less or 0°±5° or less, more preferably 90°±3° or less or 0°±3° or less, much more preferably 90°±1° or less or 0°±1° or less. These can reduce bowing by such stretching treatments as in the present invention, and a bowing strain, which is obtained by diving a deviance of the center part formed by modifying a straight line drawn along with the surface of the cellulose acylate film in the thicknesswise direction before entering a tenter to a concave portion after completion of stretching, is 10% or less, preferably 5% or less, and more preferably 3% or less.

Hereinafter, detailed description will be made on synthesizing method of the cellulose acylate suitable for the present invention, the producing method of the cellulose acylate film, and the like, according to the sequence of the procedures.

(1) Plasticizers

A raw material polymer for the production of the cellulose acylate film in the present invention is preferably added with a polyhydric alcohol plasticizer. Such a plasticizer decreases the modulus of elasticity, and also has an effect to reduce the crystal content difference between the front side and the back side. The content of the polyhydric alcohol plasticizer is preferably 2 to 20% by mass in relation to the cellulose acylate. The content of the polyhydric alcohol plasticizer is preferably 2 to 20% by mass, more preferably 3 to 18% by mass, and further more preferably 4 to 15% by mass. When the content of the polyhydric alcohol plasticizer is less than 2% by mass, the above described effect cannot be sufficiently attained; on the other hand, when larger than 20% by mass, film surface decomposition of the plasticizer (called bleeding) occurs.

Polyol plasticizers practically used in the present invention include: for example, glycerin-based ester compounds such as glycerin ester and diglycerin ester; polyalkylene glycols such as polyethylene glycol and polypropylene glycol; and compounds in which an acyl group is bound to the hydroxyl group of polyalkylene glycol, all of which are highly compatible with cellulose fatty acid ester and produce remarkable thermoplasticization effect.

Specific examples of glycerin esters include not limited to, glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include: not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystyrate, diglycerin tetramyristylate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystyrate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystyrate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystyrate, diglycerin acetate trimyristylate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, diglycerin tetraacetate, diglycerin tetrapropionate, diglycerin tetrabutyrate, diglycerin tetracaprylate and diglycerin tetralaurate are preferably used.

Specific examples of polyalkylene glycols include: not limited to, polyethylene glycols and polypropylene glycols having a weight molecular weight of 200 to 1000. Either any one of these examples or two of more of them in combination may be used.

Specific examples of compounds in which an acyl group is bound to the hydroxyl group of polyalkylene glycol include: not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

To allow these polyols to fully exert the above described effects, it is preferable to perform the melt film forming of cellulose acylate film under the following conditions. Specifically, in the film formation process where pellets of the mixture of cellulose acylate and polyol are melt in an extruder and extruded through a T-die, it is preferable to set the temperature of the extruder outlet (T2) higher than that of the extruder inlet (T1), and it is more preferable to set the temperature of the die (T3) higher than the temperature of the extruder outlet (T2). In other words, it is preferable to increase the temperature with the progress of melting of pellets. The reason for this is that if the temperature of the above mixture is rapidly increased at the inlet, polyol is first melt and liquefied, and cellulose acylate is brought to such a state that it floats on the liquefied polyol and cannot receive sufficient shear force from the screw, which results in occurrence of un-molten cellulose acylate. In such an insufficiently mixed mixture of polyol and cellulose acylate, polyol, as a plasticizer, cannot exert the above described effects; as a result, the occurrence of the difference between both sides of the melt film after melt extrusion cannot be effectively suppressed. Furthermore, such unmolten matter results in a fish-eye-like contaminant after the film formation. Such a contaminant is not observed as a brilliant point even through a polarizing plate, but it is visible on a screen when light is projected into the film from its back side. Fish eyes may cause tailing at the outlet of the die, which results in increased number of die lines.

T1 is preferably in the range of 150° C. to 200° C., more preferably in the range of 160° C. to 195° C., and more preferably in the range of 165° C. to 190° C. T2 is preferably in the range of 190° C. to 240° C., more preferably in the range of 200° C. to 230° C., and more preferably in the range of 200° C. to 225° C. It is most important that such extruder inlet and outlet temperatures T1, T2 are 240° C. or lower. If the temperatures are higher than 240° C., the modulus of elasticity of the formed film tends to be high, The reason is probably that cellulose acylate undergoes decomposition because it is melted at high temperatures, which causes crosslinking in it, and hence increase in modulus of elasticity of the formed film. The die temperature T3 is preferably 200 to less than 235° C., more preferably in the range of 205 to 230° C., and much more preferably in the range of 205 to 225° C.

(2) Stabilizer

In the present invention, it is preferable to use, as a stabilizer, either phosphite compound or phosphite ester compound, or both phosphite compound and phosphite ester compound. This enables not only the suppression of film deterioration with time, but the improvement of die lines. These compounds function as a leveling agent and get rid of the die lines formed due to the irregularities of the die. The amount of these stabilizers mixed is preferably 0.005% by weight to 0.5% by weight, more preferably 0.01% by weight to 0.4% by weight, and much more preferably 0.02% by weight to 0.3% by weight of the resin mixture.

(i) Phosphite Stabilizer

Specific examples of preferred phosphite color protective agents include: not limited to, phosphite color protective agents expressed by the following chemical formula (general formula) (1) to chemical formula (general formula) (3). 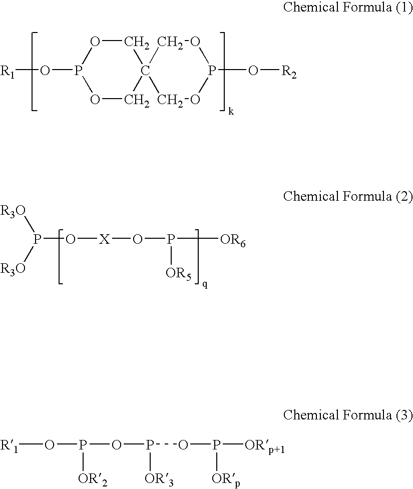
(In the above chemical formulas, R1, R2, R3, R4, R5, R6, R′1, R′2, R′3 . . . R′n, R′n+1 each represent hydrogen or a group selected from the group consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl which have 4 or more and 23 or less carbon atoms. However, for the chemical formulas (1), (2) and (3), all of these functional groups are not simultaneously hydrogen in the same respective formulas and not all the functional groups RX are simultaneously hydrogen in the respective formulas, and thus any of them are the above described functional groups (such as an alkyl group). λ in the phosphite color protective agents expressed by the chemical formula (2) represents a group selected from the group consisting of aliphatic chain, aliphatic chain with an aromatic nucleus on its side chain, aliphatic chain including an aromatic nucleus in it, and the above described chains including two or more oxygen atoms not adjacent to each other. k and q independently represents an integer of 1 or larger, and p an integer of 3 or larger.)

The k, q in the phosphite color protective agents are preferably 1 to 10. If the k, q are 1 or larger, the agents are less likely to volatilize when heating. If they are 10 or smaller, the agents have an improved compatibility with cellulose acetate propionate. Thus the k, q in the above range are preferable. p is preferably 3 to 10. If the p is 3 or more, the agents are less likely to volatilize when heating. If the p is 10 or less, the agents have improved compatibility with cellulose acetate propionate.

Specific examples of preferred phosphite color protective agents expressed by the chemical formula (general formula) (1) below include phosphite color protective agents expressed by the chemical formulas (4) to (7) below.

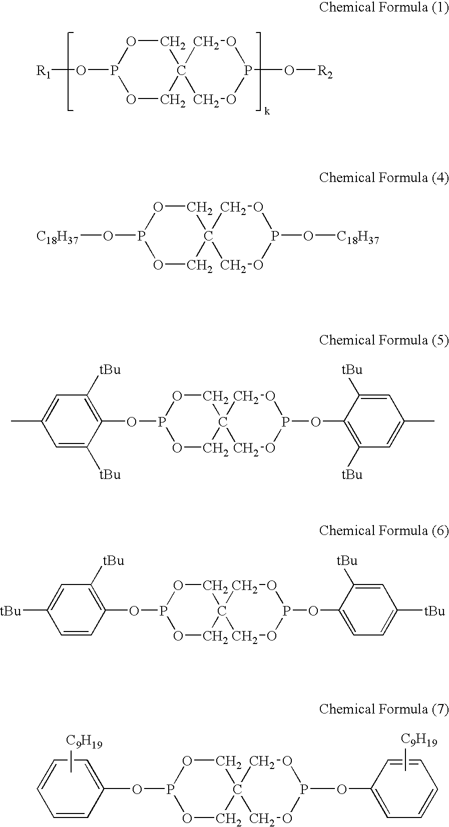

Specific examples of preferred phosphite color protective agents expressed by the chemical formula (general formula) (2) below include phosphite color protective agents expressed by the chemical formulas (8), (9) and (10) below.

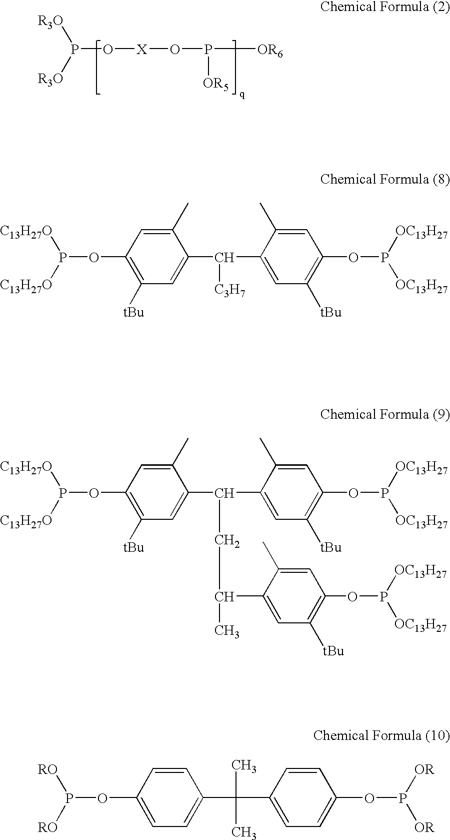

R=alkyl group with 12 to 15 carbon atoms

(ii) Phosphite ester stabilizer

Examples of phosphite ester stabilizers include: cyclic neopentane tetraylbis(octadecyl)phosohite, cyclic neopentane tetraylbis(2,4-di-t-butylphenyl)phosohite, cyclic neopentane tetraylbis(2,6-di-t-butyl-4-methylphenyl)phosohite, 2,2-methylene-bis(4,6-di-t-butylphenyl)octylphosphite, and tris(2,4-di-t-butylphenyl)phosphite.

(iii) Other Stabilizers

A weak organic acid, thioether compound, or epoxy compound, as a stabilizer, may be mixed with the resin mixture. Any weak organic acids can be used as a stabilizer in the present invention, as long as they have a pKa of 1 or more, do not interfere with the action of the present invention, and have color preventive and deterioration preventive properties. Examples of such weak organic acids include: tartaric acid, citric acid, malic acid, fumaric acid, oxalic acid, succinic acid and maleic acid. Either any one of these acids alone or two or more of them in combination may be used.

Examples of thioether compounds include: dilauryl thiodipropionate, ditridecyl thiodipropionate, dimyristyl thiodipropionate, distearyl thiodipropionate, and palmityl stearyl thiodipropionate. Either any one of these compounds alone or two or more of them in combination may be used.

Examples of epoxy compounds include: compounds derived from epichlorohydrin and bisphenol A. Derivatives from epichlorohydrin and glycerin or cyclic compounds such as vinyl cyclohexene dioxide or 3,4-epoxy-6-methylcyclohexylmethyl-3,4-epoxy-6-methylcyclohexane carboxylate can also be used. Epoxydized soybean oil, epoxydized castor oil or long-chain α-olefin oxides can also be used. Either any one of these compounds alone or two or more of them in combination may be used.

(3) Cellulose Acylate

<<Cellulose Acylate Resin>>

(Composition, Degree of Substitution)

A cellulose acylate that satisfies all of the requirements expressed by the following formula (1) to formula (3) is preferably used in the present invention.
2.0≦A+B≦3.0 formula (1)
0≦A≦2.0 formula (2)
1.0<B<2.9 formula (3)
(In the above formula (1) to formula (3), A represents the substitution degree of acetate group and B represents the sum of the substitution degrees of propionate group, butyrate group, pentanoyl group and hexanoyl group.)

A cellulose acylate that satisfies all of the requirements expressed by the following formulas (4) to (6) is preferably used in the present invention.
2.0≦A+B≦3.0 formula (4)
0≦A≦1.8 formula (5)
1.2≦B≦2.9 formula (6)

A cellulose acylate that satisfies all of the requirements expressed by the following formulas (7) to (9) is more preferably used in the present invention.
2.4≦A+B≦3.0 formula (7)
0.05≦A≦1.7 formula (8)
1.3≦B≦2.9 formula (9)

A cellulose acylate that satisfies all of the requirements expressed by the following formulas (10) to (12) is still more preferably used in the present invention.
2.5≦A+B≦2.95 formula (10)
0.1≦A≦1.55 formula (11)
1.4≦B≦2.85 formula (12)

Thus, the cellulose acylate used in the present invention is characterized in that it has propionate, butyrate, pentanoyl and hexanoyl groups introduced therein. Setting the substitution degrees in the above described range is preferable because it enables the melt temperature to be decreased and the thermal decomposition caused by melt film formation to be suppressed. Conversely, setting the substitution degrees outside the above described range is not preferable, because the melt temperature and the thermal decomposition temperature are close, and thus the thermal decomposition is hardly suppressed.

Either any one of the above cellulose acylates alone or two or more of them in combination may be used. A cellulose acylate into which a polymeric ingredient other than cellulose acylate has been properly mixed may also be used.

In the following a process for producing the cellulose acylate used in the present invention will be described in detail. The raw material cotton for the cellulose acylate according to the present invention or process for synthesizing the same are described in detail in Journal of Technical Disclosure (Laid-Open No. 2001-1745, issued on Mar. 15, 2001, Japan Institute of Invention and Innovation), pp. 7-12.

(Raw Materials and Pretreatment)

As a raw material for cellulose, one from broadleaf pulp, conifer pulp or cotton linter is preferably used. As a raw material for cellulose, a material of high purity whose α-cellulose content is 92% by mass or higher and 99.9% by mass or lower is preferably used. When the raw material for cellulose is a film-like or bulk material, it is preferable to crush it in advance, and it is preferable to crush the material to such a degree that the cellulose is in the form of fluff.

(Activation)

Preferably, the cellulose material undergoes treatment, prior to acylation, where it is brought into contact with an activator (activation). As an activator, a carboxylic acid or water can be used. A method for its addition can be selected from the group consisting of spraying, dropping and dipping.

Carboxylic acids preferably used as an activator are those having 2 or more and 7 or less carbon atoms (e.g. acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid and benzoic acid), more preferably acetic acid, propionic acid and butyric acid, and particularly preferably acetic acid.

When carrying out the activation, a catalyst for acylation such as sulfuric acid can also be added in an amount of preferably 0.1% by mass to 10% by mass of the amount of the cellulose according to the situation. Two or more activators may be used in combination or an acid anhydride of carboxylic acid having 2 or more and 7 or less carbon atoms may also be added.

The amount of activator(s) added is preferably 5% by mass or more of the amount of the cellulose, more preferably 10% by mass or more, and particularly preferably 30% by mass or more. The maximum amount of activator(s) added is not particularly limited, as long as it does not decrease the productivity; however, preferably the amount is 100 times the amount of the cellulose or less, in terms of mass, more preferably 20 times the amount of the cellulose or less, and particularly preferably 10 times the amount of the cellulose or less.

The activation duration is preferably 20 minutes or longer. The maximum duration is not particularly limited, as long as it does not affect the productivity; however, the duration is preferably 72 hours or shorter, more preferably 24 hours or shorter and particularly preferably 12 hours or shorter. The activation temperature is preferably 0° C. or higher and 90° C. or lower, more preferably 15° C. or higher and 80° C. or lower, and particularly preferably 20° C. or higher and 60° C. or lower.

(Acylation)

As a method for obtaining a cellulose acylate, any one of the methods can be used in which two kinds of carboxylic anhydrides, as acylating agents, are added in the mixed state or one by one to react with cellulose; in which a mixed acid anhydride of two kinds of carboxylic acids (e.g. acetic acid-propionic acid-mixed acid anhydride) is used; in which a carboxylic acid and an acid anhydride of another carboxylic acid (e.g. acetic acid and propionic anhydride) are used as raw materials to synthesize a mixed acid anhydride (e.g. acetic acid-propionic acid-mixed acid anhydride) in the reaction system and the mixed acid anhydride is reacted with cellulose; and in which first a cellulose acylate whose substitution degree is lower than 3 is synthesized and the remaining hydroxyl group is acylated using an acid anhydride or an acid halide. Synthesis of cellulose acylates having a large substitution degree of acyl groups at 6-position is described in, for example, official bulletins of Japanese Patent Application Laid-Open Nos. 11-5851, 2002-212338 and 2002-338601.

(Acid Anhydride)

Acid anhydrides of carboxylic acids preferably used are those of carboxylic acids having 2 or more and 7 or less carbon atoms, which include: for example, acetic anhydride, propionic anhydride, butyric anhydride, hexanoic anhydride, and benzoic anhydride. More preferably used are acetic anhydride, propionic anhydride, butyric anhydride and, hexanoic anhydride and the like. And particularly preferably used are acetic anhydride, propionic anhydride and butyric anhydride.

Usually, excess equivalent of acid anhydride(s) is added to cellulose. Specifically, preferably 1.1 equivalents to 50 equivalents, more preferably 1.2 equivalents to 30 equivalents, and particularly preferably 1.5 equivalents to 10 equivalents of acid anhydride(s) is added to the hydroxyl group of cellulose.

(Catalyst)

As an acylation catalyst for the production of a cellulose acylate used in the present invention, preferably a Bronsted acid or a Lewis acid is used. The definitions of Bronsted acid and Lewis acid are described in, for example, “Rikagaku Jiten (Dictionary of Physics and Chemistry)” 5^{th} edition (2000). As the catalyst, sulfuric acid and perchloric acid are preferable, and sulfuric acid is particularly preferable. The amount of the catalyst added is preferably 0.1% by mass to 30% by mass of the amount of cellulose, more preferably 1% by mass to 15% by mass, and particularly preferably 3% by mass to 12% by mass.

(Solvent)

When carrying out acylation, a solvent may be added to the reaction mixture so as to adjust the viscosity, reaction speed, ease of stirring or acyl substitution ratio of the reaction mixture. As such a solvent, a carboxylic acid is preferably used, and more preferably, carboxylic acids having 2 or more and 7 or less carbon atoms (which include: for example, acetic acid, propionic acid, butyric acid, hexanoic acid, and benzoic acid) are used. Particularly preferable are acetic acid, propionic acid and butyric acid. Tow or more of these solvents may be used in the form of a mixture.

(Acylation Conditions)

The acylation may be carried out in such a manner that a mixture of acid anhydride(s), catalyst and, if necessary, solvent(s) is prepared first and then the mixture is mixed with cellulose, or acid anhydride(s), catalyst and, if necessary, solvent(s) are mixed with cellulose one after another. Generally, it is preferable that a mixture of acid anhydride(s) and catalyst or a mixture of acid anhydride(s), catalyst and solvent(s) is prepared first and then the mixture, as an acylating agent, is reacted with cellulose. To suppress the temperature increase in the reactor due to the heat of reaction generated in the acylation, it is preferable to cool such an acylating agent in advance.

Acylating agent(s) may be added to cellulose at one time or in installments. Or cellulose may be added to acylating agent(s) at one time or in installments. The maximum temperature the reaction system reaches in the acylation is preferably 50° C. or lower. The reaction temperature 50° C. or lower is preferable because it can prevent depolymerization from progressing, thereby avoiding such a trouble that a cellulose acylate having a polymerization degree suitable for the purpose of the present invention is hard to obtain. The maximum temperature the reaction system reaches in the acylation is preferably 45° C. or lower, more preferably 40° C. or lower, and particularly preferably 35° C. or lower. The minimum temperature in the reaction is preferably −50° C. or higher, more preferably −30° C. or higher, and particularly preferably −20° C. or higher. Acylation duration is preferably 0.5 hours or longer and 24 hours or shorter, more preferably 1 hour or longer and 12 hours or shorter, and particularly preferably 1.5 hours or longer and 10 hours or shorter.

(Reaction Terminator)

In the method for producing a cellulose acylate used in the present invention, it is preferable to add a reaction terminator after the acylation reaction. Any reaction terminator may be used, as long as it can decompose acid anhydride(s). Examples of preferred reaction terminators include: water, alcohols (e.g. ethanol, methanol, propanol and isopropyl alcohol), and compositions including the same. It is preferable to add a mixture with a carboxylic acid such as acetic acid, propionic acid or butyric acid, particularly preferably acetic acid, and water. A carboxylic acid and water can be used at an arbitrary ratio; however, preferably the water content of the mixture is 5% by mass to 80% by mass, more preferably 10% by mass to 60% by mass, and particularly preferably 15% by mass to 50% by mass.

(Neutralizer)

In the acylation reaction termination step or after the acylation reaction termination step, a neutralizer or its solution may be added to hydrolyze excess carboxylic anhydride remaining in the reaction system, to neutralize part of or the whole carboxylic acid and esterifying catalyst in the same, to adjust the residual sulfuric acid content and the residual metal content, or the like.

Preferred neutralizers include; for example, carbonate, hydrogen carbonate, or organic acid salts of ammonium, organic quaternary ammonium, alkali metals, metals in Group 2, metals in Groups 3 to 12, or elements in Groups 3 to 15 (e.g. acetate, propionate, butyrate, benzoate, phthalate, hydrogen phthalate, citrate, and tartrate), and hydroxide thereof or oxides thereof. More preferred neutralizer include; for examples, carbonate, hydrogen carbonate, organic acid salts, hydroxide, or oxide of alkali metals or metals in Group 2, and particularly preferred neutralizers include: for example, carbonate, hydrogen carbonate, acetate, or hydroxide of sodium, potassium, magnesium, or calcium. Preferred solvents for such a neutralizer include: for example, water, organic acid (e.g. acetic acid, propionic acid and butyric acid), and mixed solvents thereof.

(Partial Hydrolysis)

In the cellulose acylate thus obtained, the sum of the substitution degrees is approximately 3. Then, to obtain a cellulose acylate with desired substitution degree, generally the obtained cellulose acylate is kept at 20 to 90° C. in the presence of a small amount of catalyst (generally acylating catalyst such as remaining sulfuric acid) and water for several minutes to several days so that the ester linkage is partially hydrolyzed and the substitution degree of the acyl group of the cellulose acylate is decreased to a desired degree (so called aging). Preferably, the catalyst remaining in the reaction system is completely neutralized with a neutralizer as described above or the solution thereof at the time when a desired cellulose acylate is obtained so as to terminate the partial hydrolysis. It is also preferable to add a neutralizer which forms a salt slightly soluble in the reaction solution (e.g. magnesium carbonate and magnesium acetate) to effectively remove the catalyst (e.g. sulfuric ester) in the solution or bound to the cellulose.

(Filtration)

To remove the unreacted matter, slightly soluble salts or other contaminants in the cellulose acylate or to reduce the amount thereof, it is preferable to filter the reaction mixture. The filtration may be carried out in any step after the completion of acylation and before the reprecipitation of the same. To control the filtration pressure or the handleability of the cellulose acylate, it is preferable to dilute the cellulose acylate with an appropriate solvent prior to filtration. A cellulose acylate solution can be obtained through the operation of filtration.

(Reprecipitation)

An intended cellulose acylate can be obtained by: mixing the cellulose acylate solution thus obtained into a poor solvent, such as water or an aqueous solution of a calboxylic acid (e.g. acetic acid and propionic acid), or mixing such a poor solvent into the cellulose acylate solution, to precipitate the cellulose acylate; washing the precipitated cellulose acylate; and subjecting the washed cellulose acylate to stabilization treatment. The reprecipitation may be performed continuously or in a batchwise operation.

(Washing)

Preferably, the produced cellulose acylate undergoes washing treatment. Any washing solvent can be used, as long as it slightly dissolves the cellulose acylate and can remove impurities; however, generally water or hot water is used. The progress of washing may be traced by any means; however, preferred means of tracing include: for example, hydrogen ion concentration, ion chromatography, electrical conductivity, ICP (high-frequency inductively coupled plasma) emission spectroscopic analysis, elemental analysis, and atomic absorption spectrometry.

(Stabilization)

To improve the stability of the cellulose acylate and reduce the odor of the carboxylic acid, it is preferable to treat the cellulose acylate having been washed with hot water with an aqueous solution of weak alkali (e.g. carbonate, hydrogencarbonate, hydroxide or oxide of sodium, potassium calcium, magnesium or aluminum).

(Drying)

In the present invention, to adjust the water content of the cellulose acylate to a desirable value, it is preferable to dry the cellulose acylate. The drying temperature is preferably O to 200° C., more preferably 40 to 180° C., and particularly preferably 50 to 160° C. The water content of the cellulose acylate of the present invention is preferably 2% by mass or less, more preferably 1% by mass or less, and particularly preferably 0.7% by mass or less.

(Form)

The cellulose acylate of the present invention can take various forms, such as particle, powder, fiber and bulk forms. However, as a raw material for films, the cellulose acylate is preferably in the particle form or in the powder form. Thus, the cellulose acylate after drying may be crushed or sieved to make the particle size uniform or improve the handleability. When the cellulose acylate is in the particle form, preferably 90% by mass or more of the particles used has a particle size of 0.5 mm to 5 mm. Further, preferably 50% by mass or more of the particles used has a particle size of 1 mm to 4 mm. Preferably, the particles of the cellulose acylate have a shape as close to a sphere as possible. And the apparent density of the cellulose acylate particles used in the present invention is preferably 0.5 g/m³ to 1.3 g/m³, more preferably 0.7 g/m³ to 1.2 g/m³, and particularly preferably 0.8 g/m³ to 1.15 g/m³. The method for measuring the apparent density is specified in JIS K-7365. The cellulose acylate particles of the present invention preferably have an angle of repose of 10 degrees to 70 degrees, more preferably 15 degrees to 60 degrees, and particularly preferably 20 degrees to 50 degrees.

(Degree of Polymerization)

The average degree of polymerization of the cellulose acylate preferably used in the present invention is 100 to 700, preferably 120 to 600, and much more preferably 130 to 450. The average degree of polymerization can be determined by intrinsic viscosity method by Uda et al. (Kazuo Uda and Hideo Saitoh, Journal of the Society of Fiber Science and Technology, Japan, Vol. 18, No. 1, 105-120, 1962) or by the molecular weight distribution measurement by gel permeation chromatography (GPC). The determination of average degree of polymerization is described in detail in Japanese Patent Application Laid-Open No. 9-95538.

### Synthesis Examples of Cellulose Acylates

The synthesis examples of the cellulose acylates used in the present invention will be described below; however, the present invention is not limited to these examples.

### Synthesis Example 1

### Synthesis of Cellulose Acetate Propionate

After spraying 0.1 part by mass of acetic acid and 2.7 parts by mass of propionic acid to 10 parts by mass of a cellulose (a hardwood pulp), the cellulose was stored at room temperature for 1 hour. Separately, a mixture composed of 1.2 parts by mass of acetic anhydride, 61 parts by mass of propionic anhydride and 0.7 part by mass of sulfuric acid was prepared, cooled to −10° C. and then mixed with the cellulose subjected to the above-mentioned pretreatment in a reaction vessel.

After an elapsed time of 30 minutes, the outside temperature of the reaction vessel was increased up to 30° C., and the reaction mixture was allowed to react for 4 hours. To the reaction vessel, 46 parts by mass of 25% aqueous acetic acid was added and the inside temperature of the reaction vessel was increased up to 60° C. and the reaction mixture thus obtained was stirred for 2 hours. Then, 6.2 parts by mass of a solution prepared by mixing the same weights of magnesium acetate tetrahydrate, acetic acid and water was added to the reaction mixture, and the reaction mixture was stirred for 30 minutes (the neutralization step). The reaction solution thus obtained was subjected to a pressurized filtration with metal sintered filters (the filtration was carried out as the two stages with the retaining particle sizes of 40 μm and 10 μm, respectively) to remove the contaminants. The reaction solution after filtration was mixed in 75% aqueous acetic acid to precipitate the cellulose acetate propionate, and then the precipitate was washed with water heated to 70° C. until the pH of the washing waste became 6 to 7. Further, the precipitate was stirred in a 0.001% aqueous solution of calcium hydroxide for 0.5 hour, and then filtered. The cellulose acetate propionate thus obtained was dried at 70° C. The cellulose acetate propionate was found to have a degree of acetylation of 0.15, a degree of propionylation of 2.62 and a total degree of acyl substitution of 2.77, as derived from the 1H-NMR and GPC measurements, a number average molecular weight of 54500 (a number average degree of polymerization DPn=173), a mass average molecular weight of 132000 (a mass average degree of polymerization DPw=419), a residual sulfuric acid content of 45 ppm, a magnesium content of 8 ppm, a calcium content of 46 ppm, a sodium content of 1 ppm, a potassium content of I ppm and an iron content of 2 ppm. A film prepared by casting a dichloromethane solution of the present sample was subjected to an observation with a polarizing microscope, and consequently, almost no contaminant was identified with the polarizer set at either an orthogonal orientation or a parallel orientation.

### Synthesis Example 2

### Synthesis of Cellulose Acetate Propionate

In a reaction vessel equipped with a stirring device and a cooling device, 80 parts by mass of cellulose (pulp) and 33 parts by mass of acetic acid were placed, and the mixture thus obtained was treated for 4 hours at 60° C. to activate the cellulose. In the mixture, 33 parts by mass of acetic anhydride, 518 parts by mass of propionic acid, 536 parts by mass of propionic anhydride and 4 parts by mass of sulfuric acid were mixed, cooled to −20° C. and then added to the reaction vessel.

Esterification was performed so that the maximum temperature in the reaction was 35° C., and at the point of time when the viscosity of the reaction solution reached 840 cP, the reaction was terminated. The temperature of the reaction mixture at the end point was adjusted to 15° C. A reaction terminator made of a mixture of 133 parts by mass of water and 133 parts by mass of acetic acid, which is cooled to −5° C., was added to the reaction mixture so that the temperature of the reaction mixture did not exceed 23° C.

The temperature of the reaction mixture was set at 60° C., partial hydrolysis was performed with stirring for 2 hours, and the partial hydrolysis was terminated in a mixed solution of acetic acid and water containing 2 equivalents of magnesium acetate to sulfuric acid. The reaction solution after the hydrolysis was subjected to sequential filtration with filter paper having retaining particle sizes of 40 μm and with metal sintered filters having retaining particle sizes of 10 μm. A polymer compound obtained by mixing the reaction solution thus obtained and the acetic acid aqueous solution was reprecipitated and washed repeatedly with hot water at 70 to 80° C. After drainage, the reprecipitate thus obtained was immersed in a 0.001% by mass aqueous solution of calcium hydroxide and stirred for 30 minutes, and then was subjected to the drainage again. Drying was carried out at 70° C. to obtain cellulose acetate propionate.

The cellulose acetate propionate thus obtained was found to have a degree of acetyl substitution of 0.42, a degree of propionyl substitution of 2.40 and a total degree of acyl substitution of 2.82, a number average molecular weight of 50200 (a number average degree of polymerization DPn=159), a mass average molecular weight of 125900 (a mass average degree of polymerization DPw=398), a residual sulfuric acid content of 85 ppm, a magnesium content of 2 ppm, a calcium content of 39 ppm, a sodium content of I ppm, a potassium content of the detection limit or less and an iron content of 3 ppm. A film prepared by casting a dichloromethane solution of the present sample was subjected to an observation with a polarizing microscope, and consequently, almost no insoluble contaminant was identified.

### Synthesis Example 3

### Synthesis of Cellulose Acetate Butyrate

In a reaction vessel equipped with a stirring device and a cooling device, 200 parts by mass of cellulose (linter) and 100 parts by mass of acetic acid were placed, and the mixture thus obtained was treated for 4 hours at 60° C. to activate the cellulose. In the mixture, 161 parts by mass of acetic acid, 449 parts by mass of acetic anhydride, 742 parts by mass of butyric acid, 1349 parts by mass of butyric anhydride and 14 parts by mass of sulfuric acid were mixed, cooled to −20° C. and then added to the reaction vessel.

Esterification was performed so that the maximum temperature in the reaction was 30° C., and at the point of time when the viscosity of the reaction solution reached 1050 cP, the reaction was terminated. The temperature of the reaction mixture at the end point was adjusted to 10° C. A reaction terminator made of a mixture of 297 parts by mass of water and 558 parts by mass of acetic acid, which was cooled to −5° C., was added to the reaction mixture so that the temperature of the reaction mixture did not exceed 23° C.

The temperature of the reaction mixture was set at 60° C., partial hydrolysis was performed with stirring for 2 hours and 30 minutes, and the partial hydrolysis was terminated in a mixed solution of acetic acid and water containing 2 equivalents of magnesium acetate to sulfuric acid. The reaction solution after the hydrolysis was subjected to sequential filtration with filter paper having retaining particle sizes of 40 μm and with metal sintered filters having retaining particle sizes of 10 μm. A polymer compound obtained by mixing the reaction solution thus obtained and the acetic acid aqueous solution was reprecipitated and washed repeatedly with hot water at 70 to 80° C. After drainage, the reprecipitate thus obtained was immersed in a 0.002% by mass aqueous solution of calcium hydroxide and stirred for 30 minutes, and then was substituted to the drainage again. Drying was carried out at 70° C. to obtain cellulose acetate butyrate.

The cellulose acetate butyrate thus obtained was found to have a degree of acetyl substitution of 1.51, a degree of butyryl substitution of 1.19 and a total degree of acyl substitution of 2.70, a number average molecular weight of 55600 (a number average degree of polymerization DPn=181), a mass average molecular weight of 139000 (a mass average degree of polymerization DPw=451), a residual sulfuric acid content of 122 ppm, a magnesium content of 3 ppm, a calcium content of 53 ppm, a sodium content of I ppm, a potassium content of 2 ppm and an iron content of 2 ppm. A film prepared by casting a dichloromethane solution of the present sample was subjected to an observation with a polarizing microscope, and consequently, almost no insoluble contaminant was identified.

(4) Other Additives

(i) Matting Agent

Preferably, fine particles are added as a matting agent. Examples of fine particles used in the present invention include: those of silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferable because they can decrease the turbidity of the cellulose acylate film. Fine particles of silicon dioxide are particularly preferable. Preferably, the fine particles of silicon dioxide have an average primary particle size of 20 nm or less and an apparent specific gravity of 70 g/liter or more. Those having an average primary particle size as small as 5 nm to 16 nm are more preferable, because they enable the haze of the film produced to be decreased. The apparent specific gravity is preferably 90 g/liter to 200 g/liter and more preferably 100 g/liter to 200 g/liter. The larger the apparent specific gravity, the more preferable, because fine particles of silicon dioxide having a larger apparent specific gravity make it possible to prepare a dispersion of higher concentration, thereby improving the haze and the agglomerates.

These fine particles generally form secondary particles having an average particle size of 0.1 μm to 3.0 μm, which exist as agglomerates of primary particles in a film and form irregularities 0.1 μm to 3.0 μm in size on the film surface. The average secondary particle size is preferably 0.2 μm or more and 1.5 μm or less, more preferably 0.4 μm or more and 1.2 μm or less, and most preferably 0.6 μm or more and 1.1 μm or less. The primary particle size and the secondary particle size are determined by observing the particles in the film with a scanning electron microscope and using the diameter of the circle circumscribing each particle as a particle size. The average particle size is obtained by averaging the 200 determinations resulting from observation at different sites.

As fine particles of silicon dioxide, those commercially available, such as Aerosil R972, R972V, R974, R812, 200, 200V, 300, R202, OX50 and TT600 (manufactured by Nippon Aerosil Co., LTD), can be used. As fine particles of zirconium oxide, those on the market under the trade name of Aerosil R976 and R811 (manufactured by Nippon Aerosil Co., LTD) can be used. Of these fine particles, Aerosil 200V and Aerosil R972V are particularly preferable, because they are fine particles of silicon dioxide having an average primary particle size of 20 nm or less and an apparent specific gravity of 70 g/liter more and they produce a large effect of reducing friction coefficient of the optical film produced while keeping the turbidity of the same low.

(ii) Other Additives

Various additives other than the above described matting agent, such as ultraviolet light absorbers (e.g. hydroxybenzophenone compounds, benzotriazole compounds, salicylate ester compounds and cyanoacrylate compounds), infrared absorbers, optical adjustors, surfactants and odor-trapping agents (e.g. amine), can be added to the cellulose acylate of the present invention. The materials preferably used are described in detail in Journal of Technical Disclosure Laid-Open No. 2001-1745 (issued on Mar. 15, 2001, Japan Institute of Invention and Innovation), pp. 17-22.

As infrared absorbers, for example, those described in Japanese Patent Application Laid-Open No. 2001-194522 can be used, while as ultraviolet light absorbers, for example, those described in Japanese Patent Application Laid-Open No. 2001-151901 can be used. Both the infrared absorber content and the ultraviolet light absorber content of the cellulose acylate are preferably 0.001% by mass to 5% by mass.

Examples of optical adjustors include retardation adjustors. And those described in, for example, Japanese Patent Application Laid-Open Nos. 2001-166144, 2003-344655, 2003-248117 and 2003-66230 can be used. The use of such a retardation adjustor makes it possible to control the in-plane retardation (Re) and the retardation across the thickness (Rth) of the film produced. Preferably, the amount of the retardation adjustor added is 0 to 10% by weight, more preferably 0 to 8% by weight, and much more preferably 0 to 6% by weight. An amount to be added is preferably 10% by mass or less, more preferably 8% by mass or less, much more preferably 6% by mass or less.

(5) Physical Properties of Cellulose Acylate Mixture

The above described cellulose acylate mixtures (mixtures of cellulose acylate, plasticizer, stabilizer and other additives) preferably satisfy the following physical properties.

(i) Loss in Weight on Heating

The term “loss in weight on heating” used means the loss in weight at 220° C. of a sample when the temperature of the sample is increased from room temperature at a temperature increasing rate of 110° C./min in an atmosphere of nitrogen gas. The loss in weight on heating of cellulose acylate can be 5% by weight or less by preparing the above described cellulose acylate mixture. The loss in weight on heating of a cellulose acylate mixture is more preferably 3% by weight or less and much more preferably 1% by weight or less. Keeping the loss in weight on heating of a cellulose acylate mixture in the above described range makes it possible to suppress the trouble occurring in the film formation (generation of air bubbles).

(ii) Melt Viscosity

For the above described cellulose acylate mixture, preferably the melt viscosity at 220° C., 1 sec⁻¹ is 100 to 1000 Pa·sec, more preferably 200 to 800 Pa·sec, and much more preferably 300 to 700 Pa·sec. Allowing the thermoplastic cellulose acetate propionate composition to have such a higher melt viscosity prevents the composition from being stretched under tension at the die outlet, thereby preventing the optical anisotropy (retardation) caused by stretch orientation from increasing. Such viscosity adjustment can be performed by any means. For example, the adjustment can be performed by adjusting the polymerization degree of cellulose acylate or the amount of an additive such as a plasticizer.

(6) Pelletization

The above described cellulose acylate mixture is preferably mixed and pelletized prior to melt film formation. In pelletization, it is preferable to dry the cellulose acylate mixture in advance; however, if a vented extruder is used, the drying step can be omitted. When drying is performed, a drying method can be employed in which the cellulose acylate and additives are heated in a heating oven at 90° C. for 8 hours or more, though drying methods applicable in the present invention are not limited to this. Pelletization can be performed in such a manner that after melting the above described cellulose acylate mixture at temperatures of 150° C. or higher and 250° C. or lower with a twin-screw kneading extruder, the molten mixture is extruded in the form of noodles, and the noodle-shaped mixture is solidified in water, followed by cutting. Pelletization may also be performed by underwater cutting in which the above described cellulose acylate and additives are melted on an extruder and extruded through a ferrule directly in water, and cutting is performed in water while carrying out extrusion.

Any known extruder, such as single screw extruder, non-intermeshing counter-rotating twin-screw extruder, intermeshing counter-rotating twin-screw extruder, intermeshing corotating twin-screw extruder, can be used, as long as it enables melt kneading.

Preferably, the pellet size is such that the cross section is 1 mm² or larger and 300 mm² or smaller and the length is 1 mm or longer and 30 mm or shorter and more preferably the cross section is 2 mm² or larger and 100 mm² or smaller and the length is 1.5 mm or longer and 10 mm or shorter. In pelletization, the above described additives may be fed through a raw material feeding opening or a vent located midway along the extruder.

The number of revolutions of the extruder is preferably 10 rpm or more and 1000 rpm or less, more preferably 20 rpm or more and 700 rpm or less, and much more preferably 30 rpm or more and 500 rpm or less. If the rotational speed is lower than the above described range, the residence time of the cellulose acylate and additives is increased, which undesirably causes heat deterioration of the mixture, and hence decrease in molecular weight and increase in color change to yellow. Further, if the rotational speed is higher than the above described range, molecule breakage by shear is more likely to occur, which gives rise to problems of decrease in molecular weight and increase in crosslinked gel.

The extrusion residence time in pelletization is preferably 10 seconds or longer and 30 minutes or shorter, more preferably 15 seconds or longer and 10 minutes or shorter, and much more preferably 30 seconds or longer and 3 minutes or shorter. As long as the resin mixture is sufficiently melt, shorter residence time is preferable, because shorter residence time enables the deterioration of resin or occurrence of yellowish color to be suppressed.

(7) Melt Film Formation

(i) Drying

The cellulose acylate mixture palletized by the above described method is preferably used, and the water content in the pellets is preferably decreased prior to the film formation. In the present invention, to adjust the water content in the cellulose acylate to a desirable amount, it is preferable to dry the cellulose acylate. Drying is often carried out using an air dehumidification drier, but the method of drying is not limited to any specific one, as long as an intended water content is obtained (preferably drying is carried out efficiently by either any one of methods, such as heating, air blasting, pressure reduction and stirring, or two or more of them in combination, and more preferably a drying hopper having an insulating structure is used). The drying temperature is preferably 0° C. to 200° C., more preferably 40° C. to 180° C., and particularly preferably 60° C. to 150° C. Too low a drying temperature is not preferable, because if the drying temperature is too low, drying takes a longer time, and moreover, water content cannot be decreased to an intended value or lower. Too high a drying temperature is not preferable, either, because if the drying temperature is too high, the resin is adhered to cause blocking. The amount of drying air used is preferably 20 m³/hour to 400 m³/hour, more preferably 50 m³/hour to 300 m³/hour, and particularly preferably 100 m³/hour to 250 m³/hour. Too small an amount of drying air is not preferable, because if the amount of drying air is too small, drying cannot be carried out efficiently. On the other hand, using too large an amount of drying air is not economical. This is because the drying effect cannot be drastically improved further even by using excess amount of drying air. The dew point of the air is preferably 0° C. to −60° C., more preferably −10° C. to −50° C., and particularly preferably −20° C. to −40° C. The drying time is required to be at least 15 minutes or longer, preferably 1 hour or longer and more preferably 2 hours or longer. However, the drying time exceeding 50 hours dose not drastically decrease the water content further and it might cause deterioration of the resin by heat. Thus, an unnecessarily long drying time is not preferable. In the cellulose acylate of the present invention, the water content is preferably 1.0% by mass or lower, more preferably 0.1% by mass or lower, and particularly preferably 0.01% by mass or lower.

(ii) Melt Extrusion

The above described cellulose acylate is fed into a cylinder via the feed opening of an extruder (different from the extruder used for the above described pelletization). The resin is preferably dried by the above described method so as to decrease the water content; however, to prevent the molten resin from being oxidized by the remaining oxygen, more preferably extrusion is performed in a stream of inert gas (nitrogen etc.) or using a vented extruder while performing vacuum evacuation. The screw compression ratio of the extruder is set to 2.5 to 4.5 and the L/D to 20 to 70. The “L/D” means the ratio of the cylinder length to the cylinder inside diameter. The extrusion temperature is set to 190° C. to 240° C. When the temperature inside of the extruder exceeds 240° C., a cooling machine should be provided between the extruder and the die.

The L/D as low as less than 20 causes insufficient melting or insufficient kneading, which makes fine crystals more likely to remain in the formed cellulose acylate film. Conversely, the L/D as high as more than 70 makes too long the residence time of the cellulose acylate resin in the extruder, which makes the resin more likely to deteriorate. Too long a residence time may cause molecule breakage, which results in decrease in molecular weight, and hence in mechanical strength of the film. Accordingly, to make the formed cellulose acylate film less likely to be yellow and less likely to break in stretching, the L/D is preferably in the range of 20 to 70, more preferably in the range of 22 to 65, and particularly preferably in the range of 24 to 50.

The extrusion temperature is preferably set in the above described temperature range. The cellulose acylate film thus obtained has the following characteristics: a haze of 2.0% or less; and a yellow index (YI value) of 10 or less.

The haze herein used is an index of whether the extrusion temperature is too low or not, in other words, an index of the amount of the crystals remaining in the formed cellulose acylate film. When the haze is more than 2.0%, the strength of the formed cellulose acylate film is likely to deteriorate and the breakage of the film is likely to occur. On the other hand, the yellow index (YI value) is an index of whether the extrusion temperature is too high or not. When the yellow index (YI value) is 10 or less, the formed cellulose acylate film is free from the problem of yellowing.

As extruder, generally single-screw extruder, which requires lower equipment costs, is often used. Types of single-screw extruder include: for example, fullflight-type, Madock-type and Dulmage-type. For the cellulose acylate, which is relatively poor in heat stability, fullflight-type screw extruder is preferably used. Twin-screw extruder which is provided with a vent midway along its length, and therefore, makes it possible to perform extrusion while removing unnecessary volatile components can also be used by changing the screw segment, though it requires high equipment costs. Types of twin-screw extruder include: broadly, corotating type and counter-rotating type, and either of the types can be used. However, preferably used is a corotating type of twin-screw extruder which causes less residence of the resin and has a high self-cleaning performance. Twin-screw extruder is suitable for the film formation of cellulose acylate, because it makes possible extrusion at low temperatures due to its high kneading performance and high resin-feeding performance, though its equipment costs are high. In twin-extruder, if a vent opening is properly arranged, pellets or powder of cellulose acylate can be used in the undried state or the selvedges of the film produced in the course of the film formation can also be reused in the undried state.

The preferable diameter of the screw varies depending on the intended amount of the cellulose acylate resin extruded per unit time; however, it is preferably 10 mm or larger and 300 mm or smaller, more preferably 20 mm or larger and 250 mm or smaller, and much more preferably 30 mm or larger and 150 mm or smaller.

(iii) Filtration

To filter contaminants in the cellulose acylate or avoid the damage to the gear pump caused by such contaminants, it is preferable to perform a so-called breaker-plate-type filtration which uses a filter medium provided at the extruder outlet. To filter contaminants with much higher precision, it is preferable to provide, after the gear pump, a filter in which a leaf-type disc filter is incorporated. Filtration can be performed with a single filtering section, or it can be multi-step filtration with a plurality of filtering sections. A filter medium with higher precision is preferably used; however, taking into consideration the pressure resistance of the filter medium or the increase in filtration pressure due to the clogging of the filter medium, the filtration precision is preferably 3 μm to 15 μm and more preferably 3 μm to 10 μm. A filter medium with higher precision is particularly preferably used when a leaf-type disc filter is used to perform final filtration of contaminants. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

(iv) Gear Pump

To improve the thickness precision, it is important to decrease the fluctuation in the amount of the discharged resin and it is effective to provide a gear pump between the extruder and the die to feed a fixed amount of cellulose acylate resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing (gear box) and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in cellulose acylate temperature, improve the transportation efficiency, decrease in the residence time of the resin in the extruder, and decrease the L/D of the extruder. Furthermore, when a filter is used to remove contaminants, if a gear pump is not used, the amount of the resin fed from the screw can sometimes vary with increase in filtration pressure. However, this variation in the amount of resin fed from the screw can be eliminated by using a gear pump.

Preferably, the residence time of the cellulose acylate, from the time the resin enters the extruder through the feed opening to the time it goes out of the die, is 2 minutes or longer and 60 minutes or shorter, more preferably 3 minutes or longer and 40 minutes or shorter, and much more preferably 4 minutes or longer and 30 minutes or shorter.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the cellulose acylate. In some cases, the portion of the gear pump where the cellulose acylate resides can be a cause of deterioration of the cellulose acylate. Thus, preferably the gear pump has a structure which allows the residence time of the cellulose acylate resin to be as short as possible. The tubes or adaptors that connect the extruder with a gear pump or a gear pump with the die should be so designed that they allow the residence time of the cellulose acylate resin to be as short as possible. Furthermore, to stabilize the extrusion pressure of the cellulose acylate whose melt viscosity is highly temperature-dependent, preferably the fluctuation in temperature is kept as narrow as possible. Generally, a band heater, which requires lower equipment costs, is often used for heating tubes; however, it is more preferable to use a cast-in aluminum heater which is less susceptible to temperature fluctuation. Further, for the purpose of stabilizing the discharge pressure in the extruder as described above, melting is preferably conducted by heating the extruder barrel with 3 or more and 20 or less divided heaters.

(v) Die

With the extruder constructed as above, the cellulose acylate is melted and the molten resin (cellulose acylate) is continuously fed into a die, if necessary, through a filter or gear pump. Any type of commonly used die, such as T-die, fish-tail die or hanger coat die, may be used, as long as it allows the residence time of the molten resin to be short. Further, a static mixer can be introduced right before the T-die to increase the temperature uniformity. The clearance at the outlet of the T-die can be 1.0 time to 5.0 times the film thickness, preferably 1.2 times to 3 times the film thickness, and more preferably 1.3 times to 2 times the film thickness. If the lip clearance is less than 1.0 time the film thickness, it is difficult to obtain a film whose surface state is good. Conversely, if the lip clearance is more than 5.0 times the film thickness, undesirably the thickness precision of the film is decreased. A die is very important equipment which determines the thickness precision of the film to be formed, and thus, one that can severely control the film thickness is preferably used. Although commonly used dies can control the film thickness at intervals of 40 mm to 50 mm, dies of a type which can control the film thickness at intervals of 35 mm or less and more preferably at intervals of 25 mm or less are preferable. In the cellulose acylate, since its melt viscosity is highly temperature-dependent and shear-rate-dependent, it is important to design a die that causes the least possible temperature uniformity and the least possible flow-rate uniformity across the width. The use of an automated thickness adjusting die, which measures the thickness of the film downstream, calculates the thickness deviation and feeds the calculated result back to the thickness adjustment, is also effective in decreasing fluctuations in thickness in the long-term continuous production of the cellulose acylate film.

In producing films, a single-layer film forming apparatus, which requires lower producing costs, is generally used. However, depending on the situation, it is also possible to use a multi-layer film forming apparatus to produce a film having 2 types or more of structure, in which an outer layer is formed as a functional layer. Generally, preferably a functional layer is laminated thin on the surface of the cellulose acylate film, but the layer-layer ratio is not limited to any specific one.

(vi) Cast

The cellulose acylate resin extruded in the form of a sheet from the die in the above described manner is cooled and solidified on cooling drums to obtain a film. In this cooling and solidifying operation, preferably carried out are adhesion enhancing methods to enhance the adhesion of the melt extruded cellulose acylate in a form of a sheet to the cooling drums by any of the methods, such as electrostatic application method, air-knife method, air-chamber method, vacuum-nozzle method or touch-roll method. These adhesion enhancing methods may be applied to either the whole surface or part of the surface of the sheet resulting from melt extrusion. A method, called as edge pinning, in which cooling drums are adhered to the edges of the sheet alone is often employed, but the adhesion enhancing method used in the present invention is not limited to this method.

Preferably, the molten resin sheet is cooled little by little using a plurality of cooling drums. Generally, such cooling is often performed using 3 cooling drums, but the number of cooling drums used is not limited to 3. The diameter of the cooling drums is preferably 100 mm or larger and 1000 mm or smaller and more preferably 150 mm or larger and 1000 mm or smaller. The spacing between the two adjacent drums of the plurality of drums is preferably 1 mm or larger and 50 mm or smaller and more preferably 1 mm or larger and 30 mm or smaller, in terms of face-face spacing.

The temperature of cooling drums is preferably 60° C. or higher and 160° C. or lower, more preferably 70° C. or higher and 150° C. or lower, and much more preferably 80° C. or higher and 140° C. or lower. The cooled and solidified sheet is then stripped off from the cooling drums, passed through take-off rollers (a pair of nip rollers), and wound up. The wind-up speed is preferably 10 m/min or higher and 100 m/min or lower, more preferably 15 m/min or higher and 80 m/min or lower, and much more preferably 20 m/min or higher and 70 n/min or lower.

The width of the film thus formed is preferably 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

When so-called touch roll method is used, the surface of the touch roll used may be made of rubber or plastics such as Teflon (registered trademark), or metal. A roll, called as flexible roll, can also be used whose surface gets a little depressed by the pressure of a metal roll having a decreased thickness when the flexible roll and the metal roll touch with each other, and their pressure contact area is increased. The temperature of the touch roll is preferably 60° C. or higher and 160° C. or lower, more preferably 70° C. or higher and 150° C. or lower, and much more preferably 80° C. or higher and 140° C. or lower.

(vii) Winding Up

Preferably, the sheet thus obtained is wound up with its edges trimmed away. The portions having been trimmed off may be reused as a raw material for the same kind of film or a different kind of film, after undergoing grinding or after undergoing granulation, or depolymerization or re-polymerization depending on the situation. Any type of trimming cutter, such as a rotary cutter, shearing blade or knife, may be used. The material of the cutter may be any such as carbon steel, stainless steel. Generally, a carbide-tipped blade or ceramic blade is preferably used, because use of such a blade makes the life of a cutter longer and suppresses the production of cuttings.

It is also preferable, from the viewpoint of preventing the occurrence of scratches on the sheet, to provide, prior to winding up, a laminating film at least on one side of the sheet. Preferably, the wind-up tension is 1 kg/m (in width) or higher and 50 kg/m (in width) or lower, more preferably 2 kg/m (in width) or higher and 40 kg/m (in width) or lower, and much more preferably 3 kg/m (in width) or higher and 20 kg/m (in width) or lower. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing surging in the film, or residual double refraction occurs due to the extension of the film. Preferably, the winding up is performed while detecting the wind-up tension with a tension control provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film.

Preferably, the winding up of the film is performed while tapering the amount of the film to be wound according to the winding diameter so that a proper wind-up tension is kept, though it can be performed while keeping the wind-up tension constant by the control with the tension control. Generally, the wind-up tension is decreased little by little with increase in the winding diameter; however, it can sometimes be preferable to increase the wind-up tension with increase in the winding diameter.

(viii) Physical Properties of Unstretched Cellulose Acylate Film

In the unstretched cellulose acylate film thus obtained preferably Re=0 nm to 20 nm and Rth=0 nm to 80 nm, more preferably Re=0 nm to 15 nm and Rth=0 nm to 70 nm, and furthermore preferably Re=0 nm to 10 nm and Rth=0 nm to 60 nm. Re and Rth represent in-plane retardation and across-the-thickness retardation, respectively. Re is measured using KOBRA 21ADH (manufactured by Oji Scientific Instruments) while allowing light to enter the unstretched cellulose acylate film normal to its surface. Rth is calculated based on three retardation measurements: the Re measured as above, and the Rth measured while allowing light to enter the film from the direction inclined at angles of +40°, −40°, respectively, to the direction normal to the film using the slow axis in plane as a tilt axis (rotational axis). Preferably, the angle θ between the direction of the film formation (across the length) and the slow axis of the Re of the film is made as close to 0°, +90° or −90° as possible. The total light transmittance is preferably 90% or higher, more preferably 91% or higher, and much more preferably 98% or higher. Preferably, the haze is 1% or lower, more preferably 0.8% or lower and much more preferably 0.6% or lower.

Preferably, the thickness non-uniformity both in the longitudinal direction and the transverse direction is 0% or more and 4% or less, more preferably 0% or more and 3% or less, and much more preferably 0% or more and 2% or less. Preferably, the modulus in tension is 1.5 kN/mm² or more and 3.5 kN/mm² or less, more preferably 1.7 kN/mm² or more and 2.8 kN/mm² or less, and much more preferably 1.8 kN/mm² or more and 2.6 kN/mm² or less. Preferably, the breaking extension is 3% or more and 100% or less, more preferably 5% or more and 80% or less, and much more preferably 8% or more and 50% or less.

Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower. Preferably, the dimensional change by heat at 80° C. per day is 0% or higher ±1% or less both in the longitudinal direction and the transverse direction, more preferably 0% or higher ±0.5% or less, and much more preferably 0% or higher ±0.3% or less. Preferably, the water permeability at 40° C., 90% rh is 300 g/m²·day or higher and 1000 g/m²·day or lower, more preferably 400 g/m²·day or higher and 900 g/m²·day or lower, and much more preferably 500 g/m day or higher and 800 g/m²·day or lower. Preferably, the average water content at 25° C., 80% rh is 1% by mass or higher and 4% by mass or lower, more preferably 1.2% by mass or higher and 3% by mass or lower, and much more preferably 1.5% by mass or higher and 2.5% by mass or lower.

(8) Stretching

The film formed by the above described process may be stretched. The Re and Rth of the film can be controlled by stretching. Preferably, stretching is carried out at temperatures of Tg (0° C.) or higher and (Tg+50° C.) or lower, more preferably at temperatures of (Tg+3° C.) or higher and (Tg+30° C.) or lower, and much more preferably at temperatures of (Tg+5° C.) or higher and (Tg+20° C.) or lower. Preferably, the stretch magnification is 1% or higher and 300% or lower at least in one direction, more preferably 2% or higher and 250% or lower, and much more preferably 3% or higher and 200% or lower. The stretching can be performed equally in both longitudinal and transverse directions; however, preferably it is performed unequally so that the stretch magnification in one direction is larger than that of the other direction. Either the stretch magnification in the longitudinal direction (MD) or that in the transverse direction (TD) may be made larger. Preferably, the smaller value of the stretch magnification is 1% or more and 30% or less, more preferably 2% or more and 25% or less, and much more preferably 3% or more and 20% or less. Preferably, the larger one is 30% or more and 300% or less, more preferably 35% or more and 200% or less, and much more preferably 40% or more and 150% or less. The stretching operation can be carried out in one step or in a plurality of steps. The term “stretch magnification” used means the value obtained using the following equation. Stretch magnification (%)=100×{(length after stretching)−(length before stretching)}/(length before stretching)

The stretching may be performed in the longitudinal direction by using 2 or more pairs of nip rolls and controlling the peripheral velocity of the pairs of nip rolls so that the velocity of the pair on the outlet side is faster than that of the other one(s) (longitudinal stretching) or in the transverse direction (in the direction perpendicular to the longitudinal direction) while allowing both ends of the film to be gripped by a chuck (transverse stretching). Further, the stretching may be performed using the simultaneous biaxial stretching method described in Japanese Patent Application Laid-Open Nos. 2000-37772, 2001-113591 and 2002-103445.

In the longitudinal stretching, the Re-to-Rth ratio can be freely controlled by controlling the value obtained by dividing the distance between two pairs of nip rolls by the width of the film (length-to-width ratio). In other words, the ratio Rth/Re can be increased by decreasing the length-to-width ratio. Further, Re and Rth can also be controlled by combining the longitudinal stretching and the transverse stretching. In other words, Re can be decreased by decreasing the difference between the percent of longitudinal stretch and the percent of the transverse stretch, while Re can be increased by increasing the difference between the same. Preferably, the Re and Rth of the cellulose acylate film thus stretched satisfy the following formulas,
Rth≧Re,
200 nm≧Re≧0 nm,
500 nm≧Rth≧30 nm,
more preferably,
Rth≧Rex×1.1,
150 nm≧Re≧10 nm,
400 nm≧Rth≧50 nm,
and furthermore preferably,
Rth≧Re×1.2,
100 nm≧Re≧20 nm,
350 nm≧Rth≧80 nm.

Preferably, the angle θ between the film forming direction (longitudinal direction) and the slow axis of Re of the film is as close to 0°, +90° or −90° as possible. Specifically, in the longitudinal stretching, preferably the angle θ is as close to 0° as possible, and it is preferably 0°±30, more preferably 0°±20 and much more preferably 0°±1°. In the transverse stretching, the angle θ is preferably 900±30 or −90°±3°, more preferably 90°±2° or −90°±2°, and much more preferably 90°±1° or −90°±1°.

The thickness of the cellulose acylate film after stretching is preferably 30 μm or more and 300 μm or less, more preferably 30 μm or more and 170 μm or less, and furthermore preferably 40 μm or more and 140 μm or less. In each of the lengthwise direction and the widthwise direction, the thickness unevenness is preferably 0% or more and 3% or less, more preferably 0% or more and 2% or less, and furthermore preferably 0% or more and 1% or less.

The physical properties of the stretched cellulose acylate film are preferably in the following range.

Preferably, the modulus in tension is 1.5 kN/mm² or more and less than 3.0 kN/mm², more preferably 1.7 kN/mm² or more and 2.8 kN/mm² or less, and much more preferably 1.8 kN/mm² or more and 2.6 kN/mm² or less. Preferably, the breaking extension is 3% or more and 100% or less, more preferably 5% or more and 80% or less, and much more preferably 8% or more and 50% or less. Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower. Preferably, the dimensional change by heat at 80° C. per day is 0% or higher ±1% or less both in the longitudinal direction and the transverse direction, more preferably 0% or higher ±0.5% or less, and much more preferably 0% or higher ±0.3% or less. Preferably, the water permeability at 40° C., 90% is 300 g/m²·day or higher and 1000 g/m²·day or lower, more preferably 400 g/m²·day or higher and 900 g/m²·day or lower, and much more preferably 500 g/m²·day or higher and 800 g/m²·day or lower. Preferably, the average water content at 25° C., 80% rh is 1% by mass or higher and 4% by mass or lower, more preferably 1.2% by mass or higher and 3% by mass or lower, and much more preferably 1.5% by mass or higher and 2.5% by mass or lower. The thickness is preferably 30 μm or more and 200 μm or less, more preferably 40 μm or more and 180 μm or less, and much more preferably 50 μm or more and 150 μm or less. The haze is 0% or more and 3% or less, more preferably 0% or more and 2% or less, and much more preferably 0% or more and 1% or less.

The total light transmittance is preferably 90% or higher, more preferably 91% or higher, and much more preferably 98% or higher.

The unstretched and stretched cellulose acylate films shows crystallinity, and a heat absorption peak caused by crystalline melting at 170 to 240° C. is exhibited by a differential scanning calorimeter (DSC). A crystalline melting heat is preferably 7 J/g or more and 20 J/g or less.

(9) Surface Treatment

The adhesion of both unstretched and stretched cellulose acylate films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 0.1 Pa to 3000 Pa (=10⁻³ to 20 Torr). Or plasma treatment at atmospheric pressure is also preferable. Plasma excitation gases are gases that undergo plasma excitation under the above described conditions, and examples of such gases include: argon, helium, neon, krypton, xenon, nitrogen, carbon dioxide, flons such as tetrafluoromethane, and the mixtures thereof. These are described in detail in Journal of Technical Disclosure (Laid-Open No. 2001-1745, issued on Mar. 15, 2001, by Japan Institute of Invention and Innovation), 30-32. In the plasma treatment at atmospheric pressure, which has attracted considerable attention in recent years, for example, irradiation energy of 20 Kgy to 500 Kgy is used at 10 Kev to 1000 Kev, and preferably irradiation energy of 20 Kgy to 300 Kgy is used at 30 Kev to 500 Kev. Of the above described types of treatment, most preferable is alkali saponification, which is extremely effective as surface treatment for cellulose acylate films. Specific examples of such treatment applicable include: those described in Japanese Patent Application Laid-Open Nos. 2003-3266, 2003-229299, 2004-322928 and 2005-76088.

Alkali saponification may be carried out by immersing the film in a saponifying solution or by coating the film with a saponifying solution. The saponification by immersion can be achieved by allowing the film to pass through a bath, in which an aqueous solution of NaOH or KOH with pH of 10 to 14 has been heated to 20° C. to 80° C., over 0.1 to 10 minutes, neutralizing the same, water-washing the neutralized film, followed by drying.

The saponification by coating can be carried out using a coating method such as dip coating, curtain coating, extrusion coating, bar coating or E-coating. A solvent for alkali-saponification solution is preferably selected from solvents that allow the saponifying solution to have excellent wetting characteristics when the solution is applied to a transparent substrate; and allow the surface of a transparent substrate to be kept in a good state without causing irregularities on the surface. Specifically, alcohol solvents are preferable, and isopropyl alcohol is particularly preferable. An aqueous solution of surfactant can also be used as a solvent. As an alkali for the alkali-saponification coating solution, an alkali soluble in the above described solvent is preferable, and KOH or NaOH is more preferable. The pH of the alkali-saponification coating solution is preferably 10 or more and more preferably 12 or more. Preferably, the alkali saponification reaction is carried at room temperature for 1 second or longer and 5 minutes or shorter, more preferably for 5 seconds or longer and 5 minutes or shorter, and particularly preferably for 20 seconds or longer and 3 minutes or shorter. It is preferable to wash the saponifying solution-coated surface with water or an acid and wash the surface with water again after the alkali saponification reaction. The coating-type saponification and the removal of orientation layer described later can be performed continuously, whereby the number of the producing steps can be decreased. The details of these saponifying processes are described in, for example, Japanese Patent Application Laid-Open No. 2002-82226 and WO 02/46809.

To improve the adhesion of the unstretched or stretched cellulose acylate film to each functional layer, it is preferable to provide an undercoat layer on the cellulose acylate film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), 32.

These surface-treatment step and under-coat step can be incorporated into the final part of the film forming step, or they can be performed independently, or they can be performed in the functional-layer providing process.

(10) Providing Functional Layer

Preferably, the stretched and unstretched cellulose acylate films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizing plate), optical compensation layer (optical compensation film), antireflection layer (antireflection film) or hard coat layer.

(i) Providing Polarizing Layer (Preparation of Polarizing Plate)

[Materials used for Polarizing Layer]

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol (PVA) and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70% to 100% and more preferably 80% to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness of the polarizing plate is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizing plate (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. (Reissued) No. 23297. Boron compounds (e.g. boric acid and borax) may also be used as a crosslinking agent. The amount of the crosslinking agent added to the binder is preferably 0.1% by mass to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

[Stretching of Polarizing Film]

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments. Oblique stretching in which stretching is performed in an oblique while tilting a film at an angle of 10 degrees to 80 degrees is more preferable.

(I) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15° C. to 50° C., preferably 17° C. to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

(II) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower, the stretching temperature is 40° C. or higher and 90° C. or lower, and the humidity during the stretching operation is preferably 50% rh or higher and 100% rh or lower.

The absorbing axis of the polarizing film thus obtained is preferably 10 degrees to 80 degrees, more preferably 30 degrees to 60 degrees, and much more preferably substantially 45 degrees (40 degrees to 50 degrees).

[Lamination]

The above described stretched and unstretched cellulose acylate films having undergone saponification and the polarizing layer prepared by stretching are laminated to prepare a polarizing plate. They may be laminated in any direction, but preferably they are laminated so that the angle between the direction of the film casting axis and the direction of the polarizing plate stretching axis is 0 degree, 45 degrees or 90 degrees.

Any adhesive can be used for the lamination. Examples of adhesives applicable include: PVA resins (including denatured PVA such as acetoacetyl, sulfonic, carboxyl or oxyalkylen group) and aqueous solutions of boron compounds. Of these adhesives, PVA resins are preferable. The thickness of the adhesive layer is preferably 0.01 μm to 10 μm and particularly preferably 0.05 μm to 5 μm, on a dried layer basis.

Examples of configurations of laminated layers are as follows:

a. A/P/A

b. A/P/B

c. A/P/T

d. B/P/B

e. B/P/T

where A represents an unstretched film of the present invention, B a stretched film of the present invention, T a cellulose triacetate film (Fujitack: Trade name), and P a polarizing layer. In the configurations a, b, A and B may be cellulose acetate having the same composition, or they may be different. In the configuration d, two Bs may be cellulose acetate having the same composition, or they may be different, and their stretching rates may be the same or different. When sheets of polarizing plate are used as an integral part of a liquid crystal display, they may be integrated into the display with either side of them facing the liquid crystal surface; however, in the configurations b, e, preferably B is allowed to face the liquid crystal surface.

In the liquid crystal displays into which sheets of polarizing plate are integrated, usually a substrate including liquid crystal is arranged between two sheets of polarizing plate; however, the sheets of polarizing plate of a to e of the present invention and commonly used polarizing plate (T/P/T) can be freely combined. On the outermost surface of a liquid crystal display, however, preferably a transparent hard coat layer, an anti-glare layer, antireflection layer and the like is provided, and as such a layer, any one of layers described later can be used.

Preferably, the sheets of polarizing plate thus obtained have a high light transmittance and a high degree of polarization. The light transmittance of the polarizing plate is preferably in the range of 30% to 50% at a wavelength of 550 nm, more preferably in the range of 35% to 50%, and most preferably in the range of 40% to 50%. The degree of polarization is preferably in the range of 90% to 100% at a wavelength of 550 nm, more preferably in the range of 95% to 100%, and most preferably in the range of 99% to 100%.

The sheets of polarizing plate thus obtained can be laminated with a λ/4 plate to create circularly polarized light. In this case, they are laminated so that the angle between the slow axis of the λ/4 plate and the absorbing axis of the polarizing plate is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

These sheets of polarizing plate may include a protective film laminated on one side and a separate film on the other side. Both protective film and separate film are used for protecting sheets of polarizing plate at the time of their shipping, inspection and the like.

(ii) Providing Optical Compensation Layer (Preparation of Optical Compensation Film)

An optically anisotropic layer is used for compensating the liquid crystalline compound in a liquid crystal cell in black display by a liquid crystal display. It is prepared by forming an orientation film on each of the stretched and unstretched cellulose acylate films and providing an optically anisotropie layer on the orientation film.

[Orientation Film]

An orientation film is provided on the above described stretched and unstretched cellulose acylate films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the oriented state of the liquid crystalline compound is fixed after it undergoes orientation treatment. In other words, the sheets of polarizing plate of the present invention can also be prepared by transferring only the optically anisotropic layer on the orientation film, where the orientation state is fixed, on the polarizing plate.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique(LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of orienting liquid crystalline molecules.

In the present invention, preferably the orientation film has not only the function of orienting liquid crystalline molecules, but also the function of combining a side chain having a crosslinkable functional group (e.g. double bond) with the main chain or the function of introducing a crosslinkable functional group having the function of orienting liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70% to 100% and more preferably 80 to 100%. The polymerization degree of polyvinyl alcohol is preferably 100 to 5000.

Side chains having the function of orienting liquid crystal molecules generally have a hydrophobic group as a functional group. The kind of the functional group is determined depending on the kind of liquid crystalline molecules and the oriented state required. For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of orienting liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazol; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1% by mass to 20% by mass of the polymer and more preferably 0.5% by mass to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.11 m to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.

The orientation film is provided on the stretched and unstretched cellulose acylate films or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.10 to 900. However, as described in Japanese Patent Application Laid-Open No. 8-160430, if the film is wrapped around the rubbing roll at 3600 or more, stable rubbing treatment is ensured. The conveying speed of the film is preferably 1 m/min to 100 m/min. Preferably, the rubbing angle is properly selected from the range of 0° to 60°. When the orientation film is used in liquid crystal displays, the rubbing angle is preferably 40° to 50° and particularly preferably 45°.

The thickness of the orientation film thus obtained is preferably in the range of 0.1 μm to 10 μm.

Then, liquid crystalline molecules of the optically anisotropic layer are oriented on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

[Rod-Shaped Liquid Crystalline Molecules]

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7.

To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

[Discotic Liquid Crystalline Molecules]

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction.

Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

[Other Compositions of Optically Anisotropic Layer]

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1% by mass to 50% by mass of the discotic liquid crystalline molecules and preferably in the range of 5% by mass to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1% by mass to 10% by mass of the liquid crystalline molecules and more preferably in the range of 0.1% by mass to 8% by mass.

The discotic nematic liquid crystal phase-solid phase transition temperature of the discotic liquid crystalline molecules is preferably 70° C. to 300° C. and more preferably 70° C. to 170° C.

[Formation of Optically Anisotropic Layer]

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include; amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 μm to 20 μm, more preferably 0.5 μm to 15 μm, and most preferably 1 μm to 10 μm.

[Fixation of Orientation State of Liquid Crystalline Molecules]

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01% by mass to 20% by mass of the solid content of the coating fluid and more preferably in the range of 0.5% by mass to 5% by mass.

Light irradiation for the polymerization of liquid crystalline molecules is preferably performed using ultraviolet light. Irradiation energy is preferably in the range of 20 mJ/cm² to 50 J/cm², more preferably 20 mJ/cm² to 5000 mJ/cm², and much more preferably 100 mJ/cm² to 800 mJ/cm². To accelerate the photopolymerization, light irradiation may be performed under heat. A protective layer may be provided on the surface of the optically anisotropic layer.

Combining the optical compensation film with a polarizing layer is also preferable, Specifically, an optically anisotropic layer is formed on a polarizing film by coating the surface of the polarizing film with the above described coating fluid for an optically anisotropic layer. As a result, thin polarlizer, in which stress generated with the dimensional change of polarizing film (distorsion×cross-sectional area×modulus of elasticity) is small, can be prepared without using a polymer film between the polarizing film and the optically anisotropic layer. Installing the polarizing plate according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizing plate laminated on both sides of a liquid crystal cell constituting LCl) and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

[Liquid Crystal Display Devices]

Liquid crystal modes in which the above described optical compensation film is used will be described.

(TN-Mode Liquid Crystal Display Devices)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

(OCB-Mode Liquid Crystal Display Devices)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

(VA-Mode Liquid Crystal Display Devices)

VA-mode liquid crystal cells are characterized in that in the cells, rod-shaped liquid crystalline molecules are oriented substantially vertically when no voltage is applied. The Va-Mode Liquid Crystal Cells Include; (1) a Va-Mode Liquid Crystal Cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

(IPS-Mode Liquid Crystal Display Devices)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

(Other Modes of Liquid Crystal Display Devices)

In ECB-mode, STN (Supper Twisted Nematic)-mode, FLC (Ferroelectric Liquid Crystal)-mode, AFLC (Anti-ferroelectric Liquid Crystal)-mode, and ASM (Axially Symmetric Aligned Microcell)-mode cells, optical compensation can also be achieved with the above described logic. These cells are effective in any of the transmissive-, reflective-, and semi-transmissive-liquid crystal display devices. These are also advantageously used as an optical compensation sheet for GH (Guest-Host)-mode reflective liquid crystal display devices. Examples of practical applications in which the cellulose derivative films described so far are used are described in Journal of Technical Disclosure (Laid-Open No. 2001-1745, Mar. 15, 2001, issued by Japan Institute of Invention and Innovation), 45-59.

Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

[Layer Configuration of Coating-Type Antireflection film]

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the antireflection film is preferably H or higher, by pencil hardness test in accordance with JIS K₅₄₀₀, more preferably 2H or higher, and most preferably 3H or higher.

[High-Refractive-Index Layer and Intermediate-Refractive-Index Layer]

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 1′-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

[Low-Refractive-Index Layer]

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35% by mass to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE (Trade name) manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing producing costs, coating method is preferable.

The thickness of the low-refractive-index layer is preferably 30 nm to 200 nm, more preferably 50 nm to 150 nm, and most preferably 60 nm to 120 nm.

[Hard Coat Layer]

A hard coat layer is provided on the surface of both stretched and unstretched cellulose acylate films so as to impart physical strength to the antireflection film. Particularly preferably the hard coat layer is provided between the stretched cellulose acylate film and the above described high-refractive-index layer and between the unstretched cellulose acylate film and the above described high-refractive-index layer. It is also preferable to provide the hard coat layer directly on the stretched and unstretched cellulose acylate films by coating without providing an antireflection layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 00/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 μm to 10 μm are added to provide the layer with the anti-glare function.

The thickness of the hard coat layer can be properly designed depending on the applications for which it is used. The thickness of the hard coat layer is preferably 0.2 μm to 10 μm and more preferably 0.5 μm to 7 μm.

The strength of the hard coat layer is preferably 1H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

[Forward Scattering Layer]

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

[Other Layers]

Besides the above described layers, a primer layer, anti-static layer, undercoat layer or protective layer may be provided.

[Coating Method]

The layers of the antireflection film can be formed by any method of dip coating, air knife coating, curtain coating, roller coating, wire bar coating, gravure coating, microgravure coating and extrusion coating (U.S. Pat. No. 2,681,294).

[Anti-Glare Function]

The antireflection film may have the anti-glare function that scatters external light. The anti-glare function can be obtained by forming irregularities on the surface of the antireflection film. When the antireflection film has the anti-glare function, the haze of the antireflection film is preferably 3% to 30%, more preferably 5% to 20%, and most preferably 7% to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1% by mass to 50% by mass) of particles having a relatively large size (0.05 μm to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

[Applications]

The unstretched and stretched cellulose acylate films of the present invention are useful as optical films, particularly as polarizing plate protective film, optical compensation sheet (also referred to as retardation film) for liquid crystal displays, optical compensation sheet for reflection-type liquid crystal displays, and substrate for silver halide photographic photosensitive materials.

(1) Preparation of Polarizing Plate

(1-1) Stretching

Stretching is carried out on the unstretched cellulose acylate films at glass transition temperatures (Tg) of each of the films +10° C. at 300%/min. Stretched cellulose acylate films can be obtained, for example, as follows: (1) when a longitudinal stretching magnification is 300% and a transverse stretching magnification is 0%, a film having Re of 200 nm and Rth of 100 nm can be obtained; (2) when a longitudinal stretching magnification is 50% and a transverse stretching magnification is 10%, a film having Re of 60 nm and Rth of 220 nm can be obtained; (3) when a longitudinal stretching magnification is 50% and a transverse stretching magnification is 50%, a film having Re of 0 nm and Rth of 450 nm can be obtained; (4) when a longitudinal stretching magnification is 50% and a transverse stretching magnification is 10%, a film having R^{e} of 60 nm and Rth of 220 nm can be obtained; and (5) when a longitudinal stretching magnification is 0% and a transverse stretching magnification is 150%, a film having R^{e} of 150 nm and Rth of 150 nm can be obtained.

(1-2) Saponification of Cellulose Acylate Films

The unstretched and stretched cellulose acylate films are saponified by the immersion saponification described below. Almost the same results are obtained for the unstretched and stretched cellulose acylate films saponified by the coating saponification.

(i) Immersion-Saponification Process

As a saponifying solution, 1.5 N NaOH aqueous solution is used. The temperature of this solution is adjusted to 60° C., and each cellulose acylate film was immersed in the solution for 2 minutes. Then, the film is immersed in 0.1 N aqueous solution of sulfuric acid for 30 seconds and passed through a water washing bath.

(ii) Coating Saponification

To 80 parts by mass of isopropanol, 20 parts by mass of water is added, and KOH is dissolved in the above mixture so that the normality of the solution is 1.5. The temperature of the solution is adjusted to 60° C. and the solution is used as a saponifying solution. The saponifying solution is applied to the cellulose acylate film at 60° C. in an amount of 10 g/m² to allow the cellulose acylate film to undergo saponification for 1 minute. Then, the saponified cellulose acylate film undergoes spray washing with hot water spray at 50° C. at a spraying rate of 10 L/m²·min for 1 minute.

(1-3) Preparation of Polarizing Layer

A polarizing layer 20 μm thick was prepared by creating a difference in peripheral velocity between two pairs of nip rolls to carry out stretching in the longitudinal direction in accordance with Example I described in Japanese Patent Application Laid-Open No. 2001-141926.

(1-4) Lamination

The polarizing layer thus obtained and the above described saponified unstretched and stretched cellulose acylate films are laminated with a 3% PVA aqueous solution (PVA-117H, manufactured by Kuraray Co., Ltd.) as an adhesive, and the lamination is performed so that the polarization axis and the longitudinal direction of the cellulose acylate film were crossed at an angle of 45 degrees. When the polarizing plate thus prepared is installed in a 20-inch VA-mode liquid crystal display device described in FIGS. 2 to 9 in Japanese Patent Application Laid-Open No. 2000-154261, and when visual evaluation is carried out obliquely from 32 degrees so that projection parallel scratches are most likely to be identified, excellent performance can be attained.

(2) Preparation of Optical Compensation Film

(i) Unstretched Film

When using the unstretched cellulose acylate film of the present invention for the first transparent substrate of Example 1 described in Japanese Patent Application Laid-Open No. 11-316378, a good optical compensation film can be prepared.

(ii) Stretched Cellulose Acylate Film

When using the stretched cellulose acylate film of the present invention, instead of the cellulose acetate film of Example 1 in Japanese Patent Application Laid-Open No. 11-316378 whose surface is coated with a liquid crystal layer, a good optical compensation film can be prepared. When using the stretched cellulose acylate film of the present invention, instead of the cellulose acetate film of Example I in Japanese Patent Application Laid-Open No. 7-333433 whose surface is coated with a liquid crystal layer, a good optical compensation film (described as the optical compensation film B) can be prepared.

(3) Preparation of Low Reflection Film

When a low reflection film is prepared with the stretched and the unstretched films of the present invention in accordance with Example 47 described in Journal of Technical Disclosure (Laid-Open No. 2001-1745) issued by Japan Institute of Invention and Innovation, good optical performance can be attained.

(4) Preparation of Liquid Crystal Display Element

The polarizing plate of the present invention is used in the liquid crystal display described in Example 1 in Japanese Patent Application Laid-Open No. 10-48420, for the optically anisotropic layer containing discotic liquid crystal molecules described in Example 1 in Japanese Patent Application Laid-Open No. 9-26572, for the orientation film whose surface was coated with polyvinyl alcohol, in the 20-inch VA-mode liquid crystal display device described in FIGS. 2 to 9 of Japanese Patent Application Laid-Open No. 2000-154261, and in the 20-inch OCB-mode liquid crystal display device described in FIGS. 10 to 15 of Japanese Patent Application Laid-Open No. 2000-154261. Furthermore, when the low reflection film according to the present invention is laminated on the outermost surface layers of these liquid crystal display devices to carry out visual evaluation, excellent visibility can be attained.

### Examples

In the following the present invention will be described in further detail by Experiments 1 to 10. It is to be noted that detailed explanation will be described in Experiment 1, and the experimental conditions in Experiments 2 to 10, which are different from Experiment 1, will be collectively described in Table 1. It is to be understood that various changes in the materials, the amount used, proportion and treatment of the same, the treatment procedure for the same, etc., which will be described in the following, may be made without departing from the spirit of the present invention. Accordingly, it is also to be understood that the scope of the present invention is not limited to the following specific examples.

### Experiment 1

(1) Pelletization of Cellulose Acylate Sheet (Cellulose Acylate Propionate)

As a cellulose resin, CAP-482-20 (manufactured by Eastman Chemical Company) was used. Hereinafter, it is referred to as CAP. A number average molecular weight of this CAP was 70000. When preparing CAP pellets, additives described in the following were added to the CAP.

| | |
|---|---|
| CAP | 100 parts by mass |
| Plasticizer: glycerin diacetate stearate | 5 parts by mass |
| Stabilizer: Triphenyl phosphite (TPP) | 3 parts by mass |
| It was dried at 100° C. for 3 hours so as to have a water content of 1 wt % or less. | |
| Mat agent: silicon dioxide particles (Aerosil R972V) | 0.05 part by mass |
| Ultraviolet light absorber: 2-(2′-hydroxy-3′,5-di-t-butylphenyl)-benzotriazol | 0.5 part by mass |
| Ultraviolet light absorber: 2,4-hydroxy-4-methoxy-benzophenone | 0.1 part by mass |

| | |
|---|---|
| | Chemical Formula (11) |
| 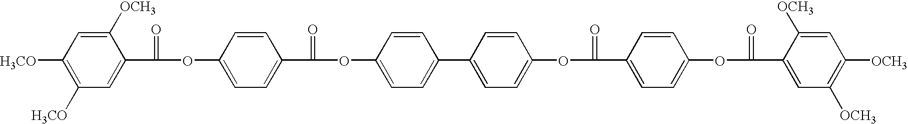 | |

The above described compound was extruded from a die with a twin-screw extruder equipped with a vacuum exhaust under the conditions at a screw rotational speed of 300 rpm, at a kneading time for 40 seconds, and at an extrusion amount of 200 kg/hr and solidified in water at 60° C., and then the extruded material was cut to obtain cylindrical pellets (CAP pellets) having a diameter of 2 mm and a length of 3 mm. This CAP pellets had a glass transition temperature Tg of 130° C.

(2) Melt-Formed Film

The CAP pellets were dried with dehumidification air having a dew point of −40° C. at 100° C. for 5 hours so as to have a water content of 0.01 wt % or less. This was charged in a hopper at 80° C. as the film raw material 25 and fed in an extruder 11. A single-screw extruder (manufactured by GM Engineering Ltd.; screw diameter: +50 mm) was used as the extruder 11. An oil of the CAP pellets having a Tg of −5° C. (=about 125° C.) was circulated inside of the screw of the extruder at 100 mm from the entry side of the screw for cooling. A retaining time of the CAP pellets inside a barrel was adjusted to 5 minutes. The barrel exit and entry were respectively set at the maximum temperature and the minimum temperature of the barrel. Thus, the CAP pellets were molten in the extruder 11. Hereinafter, it is referred to as the molten CAP in the following description. It is to be noted that a position adjusting drum 20 was not used in this experiment. The molten CAP extruded from the extruder 11 was discharged in a constant amount measured with a gear pump 12, and in discharging the molten CAP, a rotational speed of the extruder 11 was adjusted so that the molten CAP before the gear pump 12 can be controlled at a constant pressure of 10 MPa. The molten CAP discharged from the gear pump 12 was subjected to filtration with a leaf disc filter having a filtration precision of 5 μmm, and was extruded in a form of a sheet (hereinafter, referred to as sheet form CAP 26) at 240° C. from a hanger coat die 14 with a slit interval of 0.9 mm passing through a static mixer. In addition, a temperature of the hanger coat die 14 was set at 240° C.

Two infrared heaters 15 and 16 (OHC-15; manufactured by Japan Sheathe Co., Ltd.) were disposed between the die discharge opening 14a and the casting drum 17. A distances L1 and L2 between the infrared heaters 15 and 16 and the sheet form CAP 26 were adjusted to 15 mm. A heating temperature of the infrared heaters 15 and 16 was set at 300° C. An air gap H (mm; distance between the die discharge opening 14a and the casting position 17a; see FIG. 2) was set at 15 mm.

The sheet form CAP 26 was solidified on the casting drum 17 having Tg of −10° C. (=about 120° C.). A temperature decrease of the sheet form Cap 26 in the air gap H was −5° C. These were measured with thermometers 45 and 46. The casting position 17a of the sheet form CAP 26 was 230° C. In the solidification, the sheet form CAP 26 was subjected to electrostatic application on its both edges of 10 cm each in the electrostatic application method (a 10 kV wire was disposed at a position of 10 cm from a position for casting onto a casting drum for melting). The sheet form CAP 26 was peeled off from the casting drum 17. The sheet form CAP 26 was wound around the roller 31 in the cooling zone 30 that was adjusted to a desired temperature so as to convey a film 27 (hereinafter referred to as an unstretched CAP film). After the film was trimmed with its both edges (5% each to the whole width) right before winding up, it underwent a thickening process (knurling) to have a thickness of 10 mm-width and 50 μm-height, and 3000 m of the film was wound up at 5 m/min. The unstretched CAP film 27 thus obtained had a width of 1.5 m and an average thickness of 100 μm.

(3) Evaluation of the Unstretched CAP Film

(i) Measurement of Film Thickness Distribution

The thickness unevenness (film thickness distribution) measurement of the unstretched CAP film was conducted by using a continuous thickness meter (TOFUI) manufactured by Yamabun Electric Co., Ltd. The measurement was carried out in such a way that the thickness of the central portion of the film was measured at a pitch interval of 0.5 mm over a length of 3 m in the lengthwise direction. The film thickness distribution was I μm.

(ii) Measurement of Die Scratch Depth

The die scratch depth measurement of the unstretched CAP film was conducted by using Micromap 123 manufactured by Ryoka Systems Inc. The die scratch depth was 0.15 μm at the maximum.

(iii) Overall Evaluation

In view of the above described results, the overall evaluation was conducted with 4 levels described in the following;

“very good”: the case in which a film had excellent film optical property and mechanical strength;

“good”: the case in which a film had good film optical property and mechanical strength;

“average”: the case in which although a film had slight difficulties in film optical property and mechanical strength, the film could be used as a product depending on its kind; and

“poor”: the case in which a film had difficulties in film optical property and mechanical strength, the film could not be used as a product.

It is to be noted that the overall evaluation of the unstretched CAP film obtained in Experiment 1 was a film having excellent optical property and mechanical strength (“very good”).

### Experiments 2 to 7

Respective experimental conditions and results of Experiments 2 to 7 are collectively shown in Table 1. It is to be noted that a hot air heater (DF3; manufactured by Japan Sheathe Co., Ltd.) was used in Experiment 7 instead of an infrared heater. The unstretched CAP films obtained in Experiments 2 to 5, in which the experimental conditions of the present invention were satisfied, had good film optical property and mechanical strength (“good”). Although the experimental conditions of the present invention were satisfied, the unstretched CAP films obtained in Experiments 6, in which an air gap was wider, and in Experiment 7, in which a temperature decrease was larger, were films having slight difficulties (“average”).

### Experiments 8 to 10

The unstretched CAP films obtained in Experiments 8 and 9, in which the casting position temperature of an experimental condition of the present invention was not satisfied, were film that could not be used as products (“poor”). Further, the unstretched CAP film obtained in Experiment 10, in which a heater was not disposed in an air gap, was a film that also could not be used as a product (“poor”).

TABLE 1

| | Heater | | | | | | | | | |
|---|---|---|---|---|---|---|---|---|---|---|
| | | | | Disposing | Air | Casting | | Film | Die | |
| | Heating | | | position | gap | position | Temperature | thickness | scratch | |
| | temperature | | Disposition | L | H | temperature | decrease | distribution | depth | Overall |
| | (° C.) | Kinds | number | (mm) | (mm) | (° C.) | (° C.) | (μm) | (μm) | evaluation |
| Experiment | 300 | Infrared ray | Both | 15 | 15 | 230 | −5 | 1 | 0.15 | very |
| 1 | | | sides | | | | | | | good |
| Experiment | 310 | Infrared ray | One | 50 | 50 | 215 | −10 | 3.2 | 0.41 | good |
| 2 | | | side | | | | | | | |
| Experiment | 350 | Infrared ray | Both | 100 | 100 | 200 | −10 | 4.2 | 0.38 | good |
| 3 | | | sides | | | | | | | |
| Experiment | 200 | Infrared ray | Both | 20 | 20 | 190 | −17 | 5.1 | 0.48 | good |
| 4 | | | sides | | | | | | | |
| Experiment | 320 | Infrared ray | Both | 180 | 200 | 165 | −15 | 5.4 | 0.6 | good |
| 5 | | | sides | | | | | | | |
| Experiment | 350 | Infrared ray | One | 30 | 350 | 180 | −20 | 8.6 | 1.0 | average |
| 6 | | | side | | | | | | | |
| Experiment | 310 | Hot air | Both | 130 | 50 | 155 | −25 | 7.2 | 0.9 | average |
| 7 | | | sides | | | | | | | |
| Experiment | 300 | Infrared ray | One | 30 | 70 | 240 | −20 | 11 | 1.1 | poor |
| 8 | | | side | | | | | | | |
| Experiment | 280 | Infrared ray | Both | 50 | 100 | 145 | −35 | 20 | 2.1 | poor |
| 9 | | | sides | | | | | | | |

| | | | | | | |
|---|---|---|---|---|---|---|
| Experiment | Not used | 170 | −40 | 20 | 2.0 | poor |
| 10 | | | | | | |

What is claimed is:

1. A method for producing a cellulose resin film, comprising the step of:
casting a cellulose resin sheet obtained by discharging a molten cellulose resin from a die in a form of a sheet onto a drum to produce a film, wherein
the cast cellulose resin sheet has a film thickness distribution of 5 μm or less per 10 m in terms of a lengthwise direction of the film, and
the maximum value of a scratch depth on at least one surface of the cellulose resin sheet is 1 μm or less.

2. The method for producing a cellulose resin film according to claim 1, wherein
the cellulose resin sheet is heated to have a temperature within a range from (solid-solid phase transition temperature+50)° C. or higher to (solid-solid phase transition temperature+250)° C. or lower.

3. The method for producing a cellulose resin film according to claim 2, wherein
the solid-solid phase transition temperature is a glass transition temperature Tg (° C.) of the cellulose resin.

4. The method for producing a cellulose resin film according to claim 1, wherein
the cellulose resin sheet is heated with a heater.

5. The method for producing a cellulose resin film according claim 1, wherein
a distance L1 (mm) between at least one surface of the cellulose resin sheet and a surface of a first heater disposed on the one surface side is 10 mm or more and 150 mm or less.

6. The method for producing a cellulose resin film according to claim 5, wherein a length H1 (mm) for which the cellulose resin sheet is heated with the first heater in a casting direction is 5 mm or more and 300 mm or less.

7. The method for producing a cellulose resin film according to claim 5, wherein
a second heater is further disposed on a surface opposite to the one surface of the cellulose resin sheet.

8. The method for producing a cellulose resin film according to claim 7, wherein
a distance L2 (mm) between the opposite surface of the cellulose resin sheet and the surface of the second heater is 10 mm or more and 150 mm or less.

9. The method for producing a cellulose resin film according to claim 7, wherein
a length H2 (mm) for which the cellulose resin sheet is heated with the second heater in a casting direction is 5 mm or more and 300 mm or less.

10. The method for producing a cellulose resin film according to claim 4, wherein
the heater emits electromagnetic waves of 0.7 μm or more and 1000 μm or less so as to heat the cellulose resin sheet.

11. The method for producing a cellulose resin film according to claim 1, wherein
the cellulose resin sheet is subjected to leveling on the surface of the drum at the time of casting the cellulose resin sheet onto the drum.

12. The method for producing a cellulose resin film according to claim 1, wherein
a drum having an arithmetic average roughness (Ra) of the drum surface of 0.3 μm or less is used.

13. A method for producing a cellulose resin film, comprising the step of:
discharging a molten cellulose resin from a die in a form of a sheet and casting the cellulose resin sheet onto a drum to produce a film, wherein
the temperature of the cast cellulose resin sheet at the casting position is kept within a range from 150° C. or higher to 230° C. or lower.

14. The method for producing a cellulose resin film according to claim 13, wherein
the temperature decrease of the cellulose resin sheet discharged from a die until being cast onto the drum is within 20° C. or less.

15. The method for producing a cellulose resin film according to claim 13, wherein
the cellulose resin sheet is heated to have a temperature within a range from (solid-solid phase transition temperature+50)° C. or higher to (solid-solid phase transition temperature+250)° C. or lower.

16. The method for producing a cellulose resin film according to claim 15, wherein
the solid-solid phase transition temperature is a glass transition temperature Tg (° C.) of the cellulose resin.

17. The method for producing a cellulose resin film according to claim 13, wherein
the cellulose resin sheet is heated with a heater.

18. The method for producing a cellulose resin film according claim 13, wherein
a distance L1 (mm) between at least one surface of the cellulose resin sheet and a surface of a first heater disposed on the one surface side is 10 mm or more and 150 mm or less.

19. The method for producing a cellulose resin film according to claim 18, wherein a length H1 (mm) for which the cellulose resin sheet is heated with the first heater in a casting direction is 5 mm or more and 300 mm or less.

20. The method for producing a cellulose resin film according to claim 18, wherein
a second heater is further disposed on a surface opposite to the one surface of the cellulose resin sheet.

21. The method for producing a cellulose resin film according to claim 20, wherein
a distance L2 (mm) between the opposite surface of the cellulose resin sheet and the surface of the second heater is 10 mm or more and 150 mm or less.

22. The method for producing a cellulose resin film according to claim 20, wherein
a length H2 (mm) for which the cellulose resin sheet is heated with the second heater in a casting direction is 5 mm or more and 300 mm or less.

23. The method for producing a cellulose resin film according to claim 17, wherein
the heater emits electromagnetic waves of 0.7 μm or more and 1000 μm or less so as to heat the cellulose resin sheet.

24. The method for producing a cellulose resin film according to claim 13, wherein
the cellulose resin sheet is subjected to leveling on the surface of the drum at the time of casting the cellulose resin sheet onto the drum.

25. The method for producing a cellulose resin film according to claim 13, wherein
a drum having an arithmetic average roughness (Ra) of the drum surface of 0.3 μm or less is used.
